(19) United States
(12) Patent Application Publication
(10) Pub. No.: US 2007/0203688 A1
(43) Pub. Date: Aug. 30, 2007

(54) Apparatus and method for word translation information output processing

(75) Inventors: Masaru Fuji, Kawasaki (JP); Akira Ushioda, Kawasaki (JP); Tomoki Nagase, Kawasaki (JP); Seiji Okura, Kawasaki (JP); Akinari Masuyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/443,127

(22) Filed: May 31, 2006

(30) Foreign Application Priority Data
Feb. 27, 2006 (JP) 2006-50066

(51) Int. Cl. G06F 17/28

(52) U.S. Cl. 704/2

(57) ABSTRACT

When it accepts an input sentence, the present apparatus divides the input sentence into substrings through morpheme analysis and obtains a candidate word group for translation of the substrings from a machine translation dictionary. It then obtains information on occurrence of each candidate word in the candidate word group within a bilingual example sentence database and calculates their priorities based on the occurrence information. Then, it grants priority as translation to each of the candidate words to generate a prioritized candidate word group and sorts the candidate words in descending order of priority for output.

### CROSS-REFERENCE TO RELATED APPLICATIONS

This application claims priority from Japanese patent application Serial no. 2006-50066 filed Feb. 27, 2006, the contents of which are incorporated by reference herein.

### BACKGROUND OF THE INVENTION

1. Field of the Invention

The present invention relates to a word translation information processing technique for assisting in efficient decision of equivalent words in a target language while maintaining quality in translation tasks. The present invention is particularly suitable for assisting in translation tasks for which rapid and high-quality translation of a large volume of technical documents is required such as translation in a field called technical translation.

2. Description of the Related Art

When deciding an equivalent word in a target language in translation, a word considered to be most suitable is selected from a number of candidate words with reference to bilingual dictionaries or bilingual example sentences between the source language and the target language. In order to decide a word with confidence, a translator generally performs so-called word confirmation for checking whether a candidate word is suitable as translation by consulting a large amount of example sentences for every candidate word.

For efficient selection of words, there has been provided a dictionary data improvement apparatus for automatically changing priorities among words in a translation dictionary database by using a large quantity of accumulated bilingual documents (see Patent Document 1: Japanese Patent Laid-Open 2000-172690, for example).

Example sentence search has been also known that accumulates a large amount of bilingual sentences that were previously translated and searches for many example sentences from those bilingual sentences that include a candidate word through search function for presentation to a translator.

Also, machine translation techniques that utilize large-scale dictionaries for specialized fields are known as techniques for assisting in word decision. Machine translation utilizing specialized dictionaries promptly outputs a machine-translated sentence in which a word from a technical terminology dictionary is embedded for an inputted word.

The apparatus according to Patent Document 1, one of prior art, automatically changes priorities of candidate words for use in machine translation. However, since no information for gaining confidence in highly ranked candidate words is added or presented, a translator is required to go through a task for gaining certainty of selection from highly ranked candidate words. The translator has to repeat a search for example sentences and read returned bilingual sentences for each candidate word. Consequently, the apparatus does not probably contribute to significant improvement of efficiency in word selection.

In addition, when example sentence search function is employed for word confirmation, information presented as a search result is a long example sentence itself. Thus, the translator has to spend a long time to read the presented sentence to locate the necessary candidate word contained in it. Further, the translator has to repeat such an example sentence search for every candidate word, which could be a heavy burden on the translator.

Machine translation can rapidly output a machine-translated sentence containing a word that is automatically adopted from candidate words. However, a word contained in the result of machine translation is automatically selected in machine translation from a plurality of candidate words for each word inputted. To check the reliability of a word, the translator has to perform word confirmation. There has been no way to reduce time required for the task of searching for example sentences for each word outputted in machine translation and reading returned sentences to check whether the word is appropriate.

In translation, time spent on word decision accounts for much of the total work hours. This has hindered improvement of efficiency of the overall translation task. The current situation is that word confirmation performed when deciding translation particularly takes a considerable time. Accordingly, there has been a need for an assistance technique for efficient decision of translation including word confirmation.

### SUMMARY OF THE INVENTION

An object of the invention is to provide a processing technique for assisting in efficient decision of translation that is capable of pairwise output of a candidate word and information indicating its priority for presentation that is determined based on occurrence information indicating the frequency the candidate word appears in bilingual example sentences and the like.

Another object of the invention is to provide a processing technique that is capable of outputting bilingual example sentences that are a pair of a source language sentence containing an input word and a target language sentence containing a word that is a candidate for the translation of the input word with those words aligned for the purpose of assisting in efficient confirmation of words.

Yet another object of the invention is to provide a processing technique that is capable of, when outputting a translated sentence generated in machine translation, determining the reliability of a word adopted in machine translation from its frequency of occurrence in example sentences and varying the display form of the word according to its reliability, for facilitating determination of necessity of word confirmation.

The present invention is a processing apparatus that comprises 1) a translation dictionary in which words in a target language corresponding to words in a source language are accumulated; 2) a machine translation section that applies machine translation process to an input sentence written in the source language to generate a translated sentence in the target language, and obtains one or more candidate words extracted from the translation dictionary for each of substrings of the input sentence that are generated through morpheme analysis executed in the machine translation section; 3) a bilingual example sentence database which accumulates bilingual example sentences that are pairs of source language sentences written in the source language and corresponding target language sentences written in the target language and that have certain analysis information added thereto for both source language and target language example sentences; 4) a candidate word priority calculation section that calculates the priority for output of each candidate for the substrings based on its occurrence information that indicates the frequency the candidate word appears in bilingual example sentences in the bilingual example sentence database; 5) a prioritized candidate word generation section that generates a prioritized candidate word that is obtained by granting priority to a candidate word; and 6) a prioritized candidate word output processing section that sorts one or more prioritized candidate words corresponding to a specified substring of the input sentence in descending order of priority and displays the same.

The invention operates as follows when it translates a sentence inputted for processing (an input sentence) from a source language to a target language.

Initially, the machine translation section applies machine translation process to an input sentence written in the source language to generate a sentence in the target language. Then, it retrieves one or more candidate words extracted from a translation dictionary for each substring of the input sentence that is obtained by dividing the input sentence through morpheme analysis executed in the machine translation process. The candidate word priority calculation section calculates the priority for output of each candidate word for a substring based on occurrence information that indicates the frequency the candidate word appears in bilingual example sentences of the bilingual example sentence database. The candidate word generation section grants priority to candidate words to generate prioritized candidate words. The prioritized candidate word output processing section sorts one or more prioritized candidate words corresponding to a specified substring of the input sentence in descending order of priority and displays the same.

According to the invention, on the assumption that there is correlation between the frequency a candidate word appears in the bilingual example sentence database and the possibility of it being selected as translation, the priority of a candidate word for output is determined based on information on its occurrence in bilingual example sentences, so that candidate words can be presented concisely being sorted in descending order of priority and together with their priorities. This enables efficient decision of translation because a user can view candidate words that are likely to be selected confirming their supporting information when deciding translation.

Further, the invention can calculate priority of a candidate word taking into consideration information on dictionaries containing a candidate word and information on history of selection and use of a candidate word, in addition to information on occurrence in bilingual example sentences. This can narrows down candidate words themselves so that the user can see candidate words and decide a word efficiently.

The present invention is also a processing apparatus that comprises a word replacement section that adopts a candidate word with the highest priority as translation in a translated sentence from among candidate words for a substring of an input sentence, and replaces a word in the translated sentence with the highest priority candidate word; a word reliability calculation section that calculates the reliability of the highest priority candidate word as translation from a certain priority distribution and grants the reliability to the highest priority candidate word put into the translated sentence; and a translated sentence output section that changes the highest priority candidate word put into the translated sentence to a certain display form reflecting its reliability and outputs the translated sentence.

According to the invention, a word in a translated sentence can be replaced with a candidate word with the highest priority and the candidate word put into the sentence itself can be changed to a display form reflecting its word reliability before the translated sentence is output. This allows the user to see the reliability of a word and determine whether the word requires confirmation or not promptly just by looking at its display form in the translated sentence, which enables efficient decision of translation.

The present invention is a processing apparatus that comprises a bilingual example sentence output section that extracts bilingual example sentences containing a candidate word specified from candidate words for a substring of an input sentence from a bilingual example sentence database, and displays the extracted example sentences with the substring corresponding to the candidate word in the source language sentence and the candidate word in the target language sentence aligned.

According to the invention, an example sentence in the target language in which a candidate word appears can be displayed with a corresponding sentence in the source language, and further the candidate word and a corresponding source language portion can be displayed aligned vertically relative to the orientation of the sentences, for example. This allows the user to readily locate the candidate word of interest and a corresponding portion from long example sentences so that the user can decide translation efficiently.

The invention is also a processing apparatus that comprises a candidate word combination generation section that generates inflected forms from candidate words obtained by a machine translation section and combines/sorts the candidate words and their inflected forms to generate candidate word combinations for search, wherein a candidate word priority calculation section calculates the priority for each of the candidate word combinations for search.

According to the invention, when candidate words for compound words are presented, priorities among candidate words for individual words constituting a compound word as well as priorities among candidate words as compound words are calculated, and candidate words can be sorted based on their priority for display. This presents candidate words as compound words and their priorities so that the user can efficiently decide a compound word.

Thus, according to the invention, candidate words for each substring of an input sentence are displayed in descending order of priority together with their priorities determined from their occurrence information. Consequently, the user can select a candidate word efficiently that is likely to be selected as translation with confirmation of supporting information.

Also, when bilingual example sentences that contain the input word and a candidate word are output, the word of interest and a candidate word are displayed being aligned concisely. The user thus can easily locate a portion in which the user is interested in from long example sentences, which enables efficient confirmation of words.

In addition, a word in a translated sentence that is generated in machine translation process is displayed in a display form reflecting its reliability. Thus, the user can efficiently determine whether the word requires confirmation.

Accordingly, efficiency of word decision, which is most time-consuming in translation, can be improved, and efficiency of overall translation task could be improved.

### BRIEF DESCRIPTION OF THE DRAWINGS

FIG. 1 illustrates the principle of the invention;

FIG. 2 shows an exemplary configuration of the invention in the first embodiment;

FIG. 3 is a process flow of the invention in the first embodiment;

FIG. 4 illustrates substrings of an input sentence and their candidate word groups;

FIG. 5 illustrates a search of a bilingual example sentence database;

FIG. 6 illustrates sorting by candidate word priority;

FIG. 7 illustrates an example of a display screen for a case output is routed to a display device;

FIG. 8 shows an exemplary configuration of the invention in the second embodiment;

FIG. 9 shows a process flow of the invention in the second embodiment;

FIG. 10 shows an example of a dictionary weight configuration screen;

FIG. 11 shows an example of a machine translation dictionary consisting of a plurality of specialized dictionaries;

FIG. 12 illustrates adjustment of candidate word priority with dictionary weight;

FIG. 13 illustrates an exemplary configuration of the invention in the third embodiment;

FIG. 14 shows a process flow of the invention in the third embodiment;

FIG. 15 illustrates a search of candidate word selection history information database;

FIG. 16 illustrates adjustment of candidate word priority with the number of selections;

FIG. 17 shows an exemplary configuration of the invention in the fourth embodiment;

FIG. 18 shows a process flow of the invention in the fourth embodiment;

FIG. 19A and 19B illustrate examples of word reliability rules;

FIG. 20 illustrates replacement with the highest priority candidate in a machine-translated sentence and output of the same;

FIG. 21 shows an exemplary configuration of the invention in the fifth embodiment;

FIG. 22 shows a process flow of the invention in the fifth embodiment;

FIG. 23 shows a detailed process flow of bilingual example sentence output;

FIG. 24 illustrates output of bilingual example sentences;

FIG. 25 shows another exemplary configuration of the invention in the fifth embodiment;

FIG. 26 shows a detailed process flow of bilingual example sentence output;

FIG. 27 illustrates output of sorted bilingual example sentences;

FIG. 28 shows an exemplary configuration of the invention in the sixth embodiment;

FIG. 29 shows a process flow of the invention in the sixth embodiment;

FIG. 30 illustrates generation of compound search candidate word combinations;

FIG. 31 illustrates search for monolingual example sentences with compound word search candidate word combinations; and

FIG. 32 illustrates sorting of compound search candidate word combinations by candidate word priority.

### DETAILED DESCRIPTION OF THE PREFERRED EMBODIMENTS

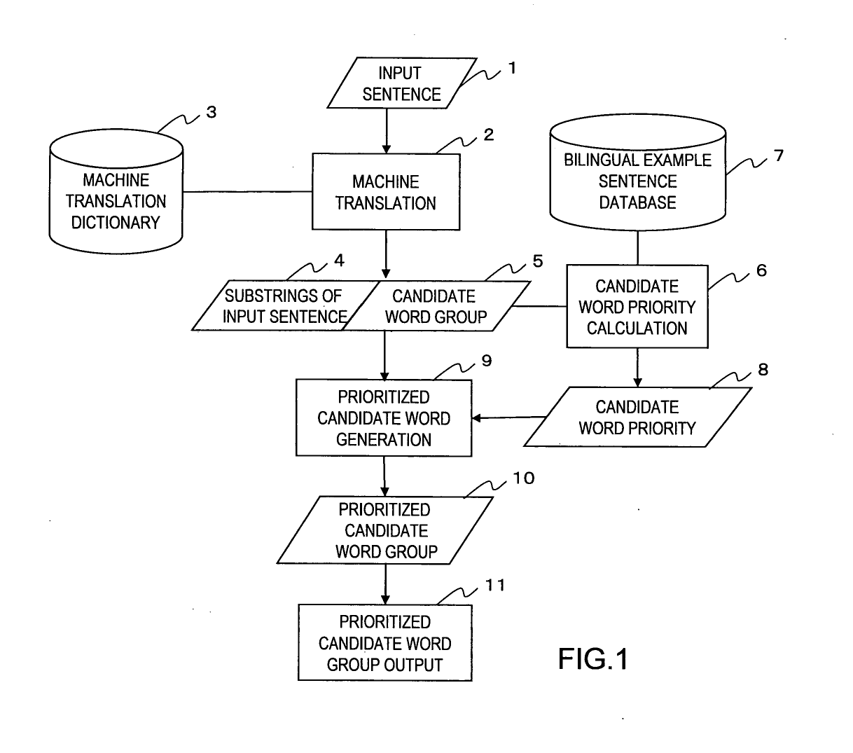

The principle of the invention will be described with reference to FIG. 1. When an input sentence 1 written in a source language that is input from an input device is accepted, a translated sentence in a target language is generated through a certain machine translation process in a machine translation process 2. At this point, the input sentence 1 is divided into substrings 4 through morpheme analysis executed in machine translation process. For each of the substrings 4 from which any functional word is removed, one or more candidate words (candidate word group 5) are extracted from a machine translation dictionary 3.

The machine translation dictionary 3 is a database in which dictionary information such as words in the target language corresponding to words in the source language corresponding are accumulated. Then, at candidate word priority calculation process 6, for each of the candidate words in the candidate word group 5 for the substring 4, information on occurrence of a candidate word in bilingual example sentences that are accumulated in a bilingual example sentence database 7 is obtained, and candidate word priority 8 is calculated based on the occurrence information.

The bilingual example sentence database 7 is a database which accumulates bilingual example sentences that are pairs of source language sentences written in the source language and corresponding sentences written in the target language and that have analysis information added for both the source and target language sentences. The analysis information is information that results from processing such as morpheme analysis and parsing.

Specifically, in this process, a candidate word is taken from the candidate word group 5, and the bilingual example sentence database 7 is searched for bilingual example sentences with the pair of the substring 4 and the taken candidate word as the search key. From the search result, occurrence information is obtained such as the number of times or frequency the candidate word appears in bilingual example sentences. Based on the occurrence information, candidate word priority 8 is calculated.

Then, at prioritized candidate word generation process 9, the candidate word priority 8 is given to each candidate in the candidate word group 5 so as to generate a prioritized candidate word group 10. Candidate word priority calculation 6 is done for all the candidate words to determine their candidate word priorities 8, and the prioritized candidate word group 10 is obtained at the prioritized candidate word generation process 9.

Further, at prioritized candidate word group output process 11, the candidates in the prioritized candidate word group 10 are sorted in descending order of priority and they are output on a display device, for example.

In the following, embodiments of the invention will be described. Description of the embodiments will be given with reference to translation between Japanese as the source language and English as the target language. However, the present invention can be applied to translation between any languages.

### First Embodiment

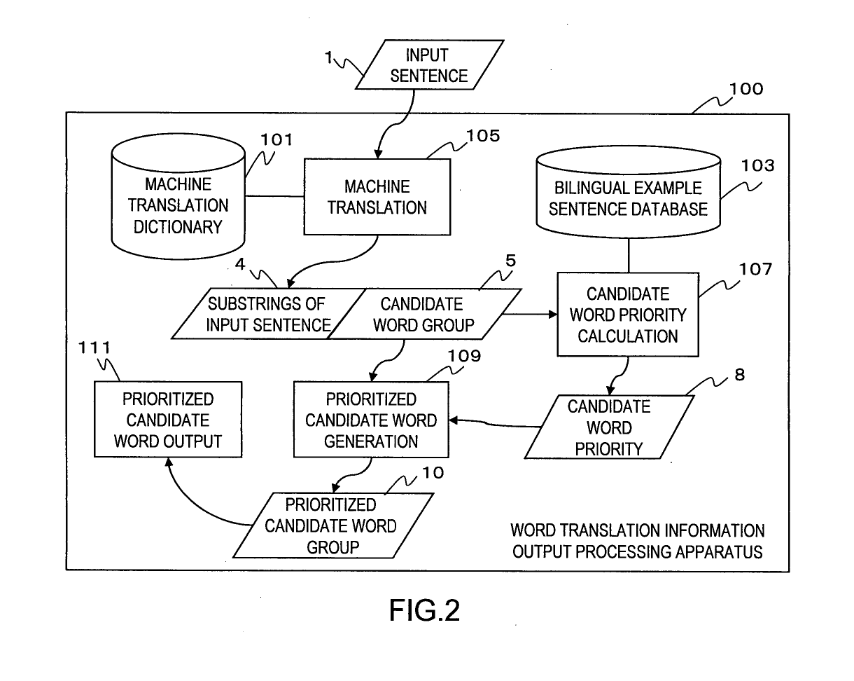

FIG. 2 illustrates an exemplary configuration of the invention in the first embodiment. A word translation information output processing apparatus 100 includes a machine translation dictionary 101, a bilingual example sentence database 103, a machine translation section 105, a candidate word priority calculation section 107, a prioritized candidate word generation section 109, and a prioritized candidate word output section 111.

The machine translation dictionary 101 is a dictionary database which defines lemmas in Japanese and associated equivalent words in English as bilingual information between Japanese and English.

The bilingual example sentence database 103 is a database which stores bilingual example sentences that are pairs of example sentences written in Japanese, the source language, (source language sentence), and example sentences written in English, the target language (target language sentences). The bilingual example sentences accumulated in the bilingual example sentence database 103 have case frame information added thereto as analysis information that is extracted through morpheme analysis and parsing. This enables bilingual example sentences to be searched with a morpheme in a source language sentence or a morpheme in a target language sentence as the key. The bilingual example sentence database 103 can also return bilingual example sentences extracted with a search key and the number of extracted bilingual example sentences (i.e., a hit count) as a search result.

The machine translation section 105 generates a machine translated sentence by certain machine translation process from the input sentence 1 in Japanese inputted from an input device (not shown). It is a process that divides the input sentence 1 into substrings 4 through morpheme analysis executed in the course of its machine translation process, extracts a candidate word group 5 for a substring 4 from the machine translation dictionary 101 and generates a translated sentence for the input sentence 1.

The candidate word priority calculation section 107 is a process means that takes a candidate word from the candidate word group 5 for a substring 4, and calculates its candidate word priority 8 based on the number of bilingual example sentences (the hit count) including the candidate word that result from a search of the bilingual example sentence database 103 performed with the substring 4 and the taken candidate word as the search key.

The prioritized candidate word generation section 109 is process means that gives candidates in the candidate word group 5 their respective candidate word priorities 8 to generate the prioritized candidate word group 10.

The prioritized candidate word output section 111 is process means that sorts the candidates in the prioritized candidate word group 10 in descending order of priority and outputs the sorted prioritized candidate word group 10 for each of the substrings 4 for the input sentence 1 on a display device (not shown), for example.

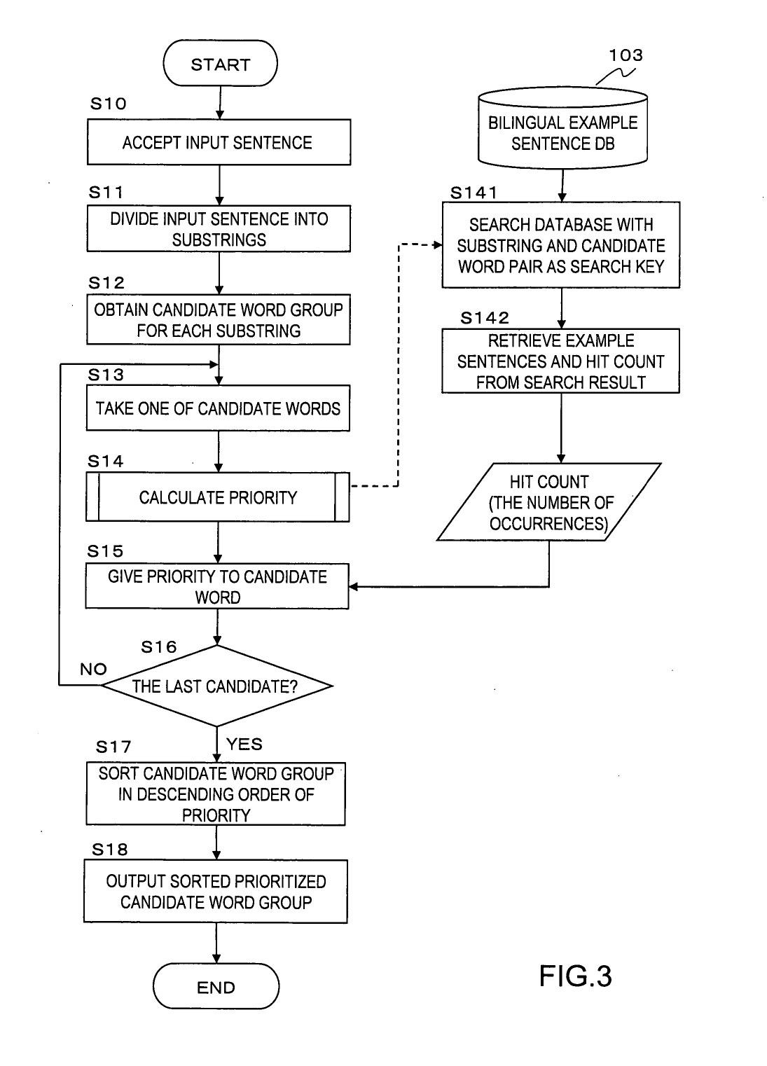

FIG. 3 shows a process flow of the invention in the first embodiment. In the word translation information output processing apparatus 100, when the machine translation section 105 accepts an input sentence 1 (step S10), it divides the input sentence 1 into substrings 4 through morpheme analysis (step S11). Based on the machine translation dictionary 101, it obtains a candidate word group 5 for each of the substrings 4 excluding functional words such as particles (step S12).

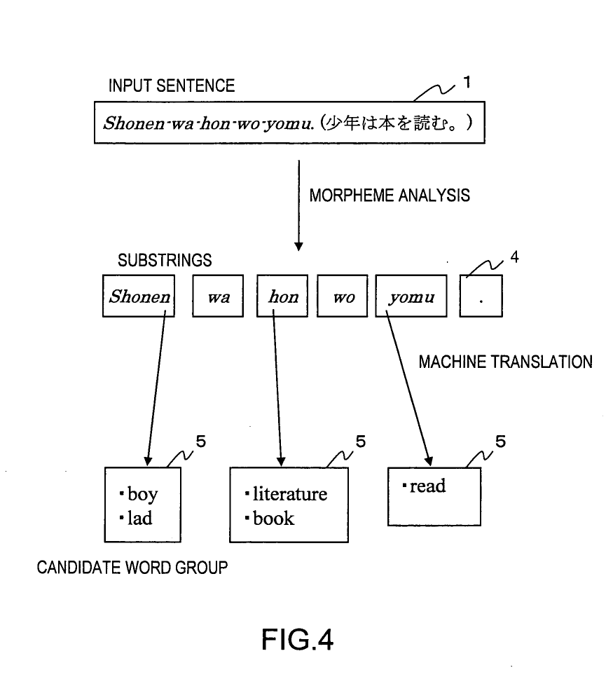

For example, as shown in FIG. 4, when an input sentence “Shonen-wa-hon-wo-yomu ( [symbol] [symbol] [symbol] [symbol] [symbol] (A boy read a book)).” is accepted, the input sentence 1 is divided into substrings 4 of “shonen ( [symbol] (boy))”, ” wa ( [symbol] (case particle))”, “hon ( [symbol] (book))”, “wo ( [symbol] (case particle))”, “yomu ( [symbol] (read))”, “ [symbol] (period)”. Among these substrings 4, for each of the substrings “shonen ( [symbol] )”, “hon ( [symbol] )”, and “yomu ( [symbol] )”, a candidate word group 5 is obtained. For example, for the substring “hon (*)”, a candidate word group 5 that consists of two candidate words “literature” and “book” is obtained.

Further, the candidate word priority calculation section 107 takes the candidates in the candidate word group 5 one by one (step S13), and calculates their priorities (step S14).

More detailed process at the priority calculation (step S14) is as follows. When the candidate word priority calculation section 107 requests a search of the bilingual example sentence database 103, the bilingual example sentence database 103 searches for bilingual example sentences accumulated therein with the pair of the substring 4 and the taken candidate word as the search key (step S141). Then, it retrieves bilingual example sentences and the number of the bilingual example sentences (hit count) as the search result, and returns them to the candidate word priority calculation section 107 (step S142).

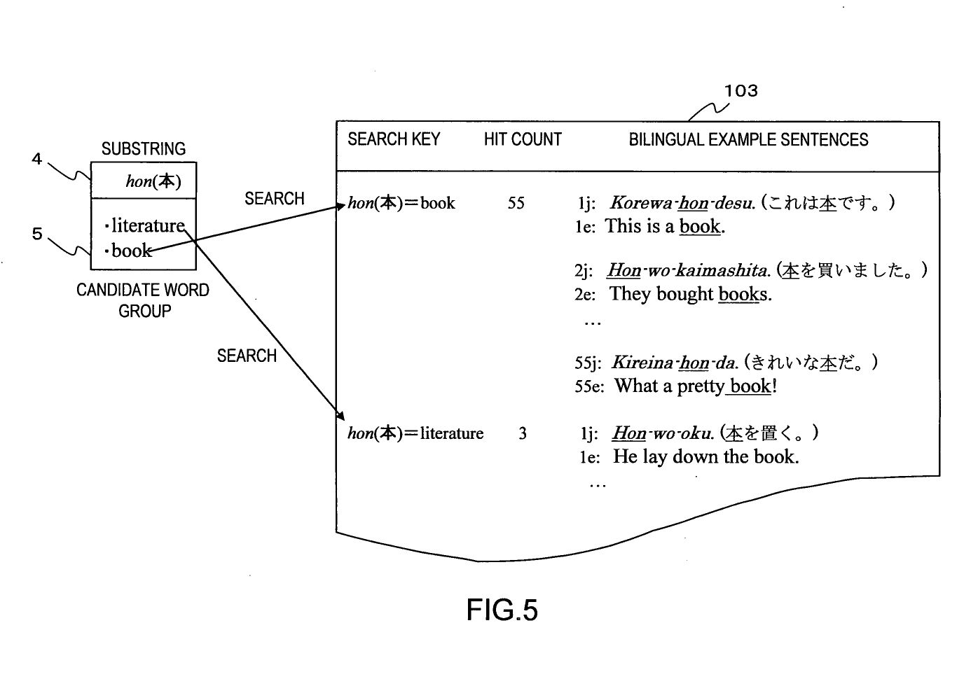

As illustrated by FIG. 5, the bilingual example sentence database 103 is searched with the pair of the substring “hon ( [symbol] )” and the candidate word “book” (hon ( [symbol] )=book) as the search key. Assume that 55 sentences hit (are extracted) as bilingual example sentences that include “hon ( [symbol] )” in source language example sentences and “book” in target language example sentences. From the number of hits, the candidate word priority 8 of the candidate word “book” is set to 55.

Similarly, if three sentences hit in a search of the bilingual example sentence database 103 with the pair of the substring “hon ( [symbol] )” and candidate word “literature” as the search key (hon( [symbol] )=literature), the candidate word priority 8 of the candidate word “literature” is set to 3 from the number of hits.

Subsequently, the prioritized candidate word generation section 109 adds the resulting candidate word priority 8 to the candidates in the candidate word group 5 so as to generate the prioritized candidate word group 10 (step S15).

If the processed candidate word is not the last candidate for the input sentence 1 (NO at step S16), the procedure returns to step S13 and repeats steps S13 through S15 until the current candidate is the last candidate word (YES at step S16). Then, the prioritized candidate word output section 111 sorts the candidates in the prioritized candidate word group 10 for the substring 4 in descending order of candidate word priority 8 (step S17), and outputs the sorted prioritized candidate word group 10 (step S18).

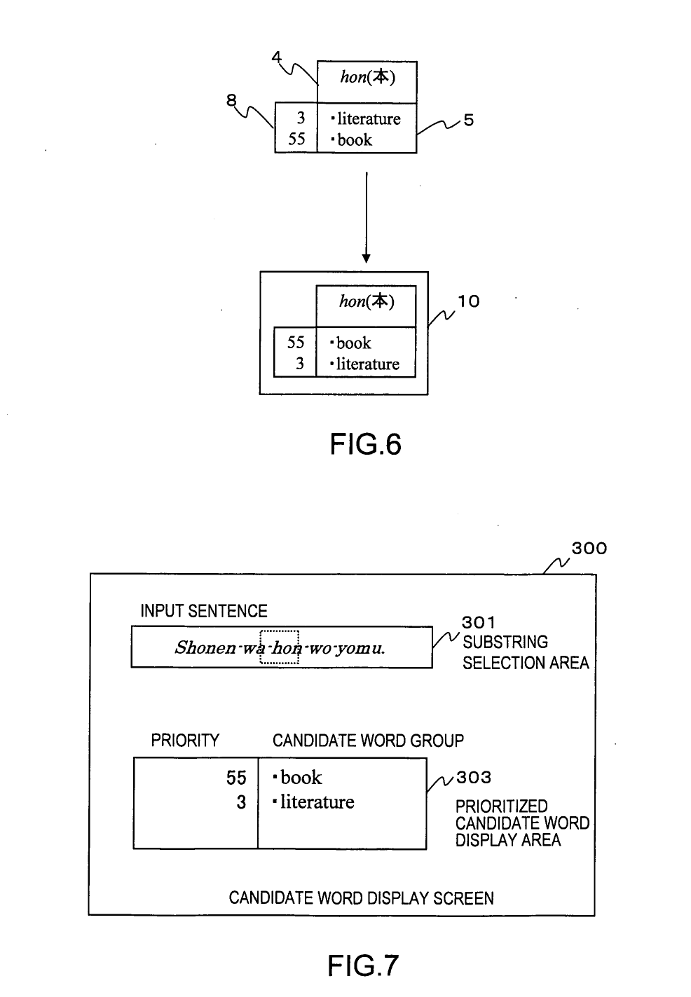

As shown in FIG. 6, assume that the order extracted as the candidate word group 5 is “literature”—“book”. Based on their candidate word priorities 8, the candidates in the prioritized candidate word groups 10 are sorted in the order of “book”—“literature”.

FIG. 7 illustrates an exemplary display screen for a case output is routed to a display device. A candidate word group display screen 300 includes a substring selection area 301 and a prioritized candidate word display area 303. The substring selection area 301 is an area in which the input sentence 1 is displayed and a substring 4 for which display of a prioritized candidate word group 10 is desired is selected. The prioritized candidate word display area 303 is an area for displaying candidates in prioritized candidate word group 10 for a substring 4 that is selected in the substring selection area 301 and their priorities as sorted in descending order.

This enables a user to see candidate words and their priorities when there are a number of candidate words for a certain substring 4 of the input sentence 1.

### Second Embodiment

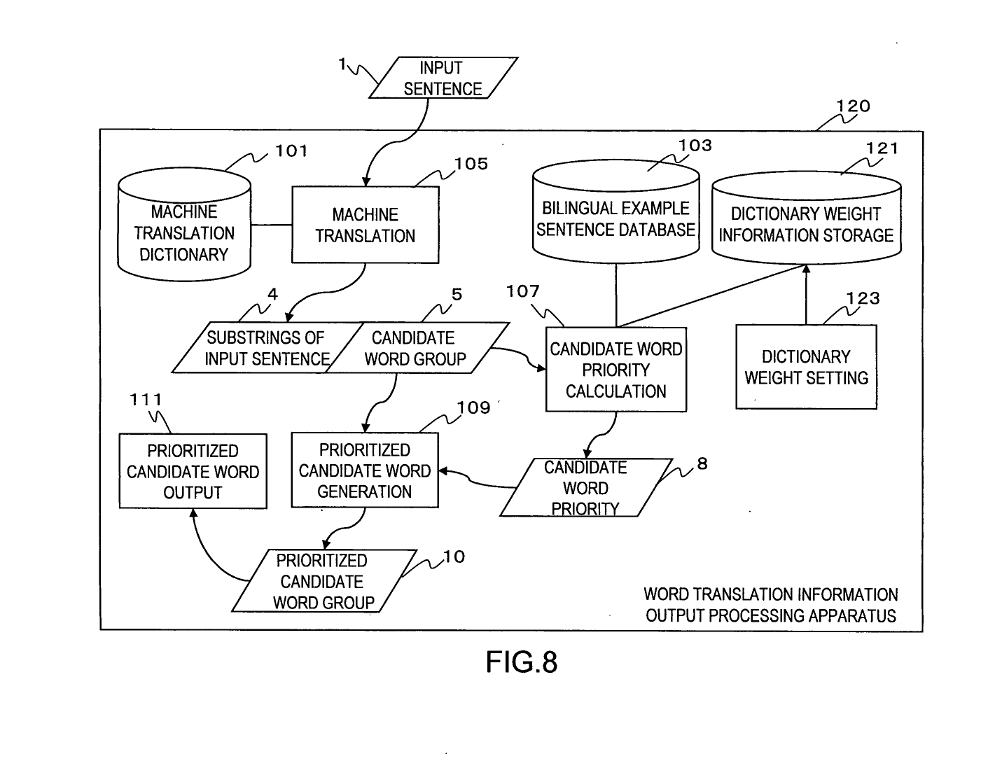

FIG. 8 illustrates an exemplary configuration of the invention in the second embodiment. A word translation information output processing apparatus 120 includes the machine translation dictionary 101, the bilingual example sentence database 103, the machine translation section 105, the candidate word priority calculation section 107, the prioritized candidate word generation section 109, the prioritized candidate word output section 111, a dictionary weight information storage section 121, and a dictionary weight setting section 123.

The word translation information output processing apparatus 120 consists of the configuration of the word translation information output processing apparatus 100 shown in FIG. 2 plus the dictionary weight information storage section 121 and dictionary weight setting section 123.

Among the process means of the word translation information output processing apparatus 120, those denoted with the same number as process means of the word translation information output processing apparatus 100 perform the same process. The same applies to embodiments to be discussed hereinafter.

The dictionary weight information storage section 121 is storage means for storing dictionary weight information configured by a user. The dictionary weight setting section 123 is process means that sets dictionary weight information according to user input and stores such information in the dictionary weight information storage section 121.

Dictionary weight information is a weighting value for presenting words found in specialized dictionaries preferentially when the machine translation dictionary 101 consists of a plurality of specialized dictionaries for a certain field.

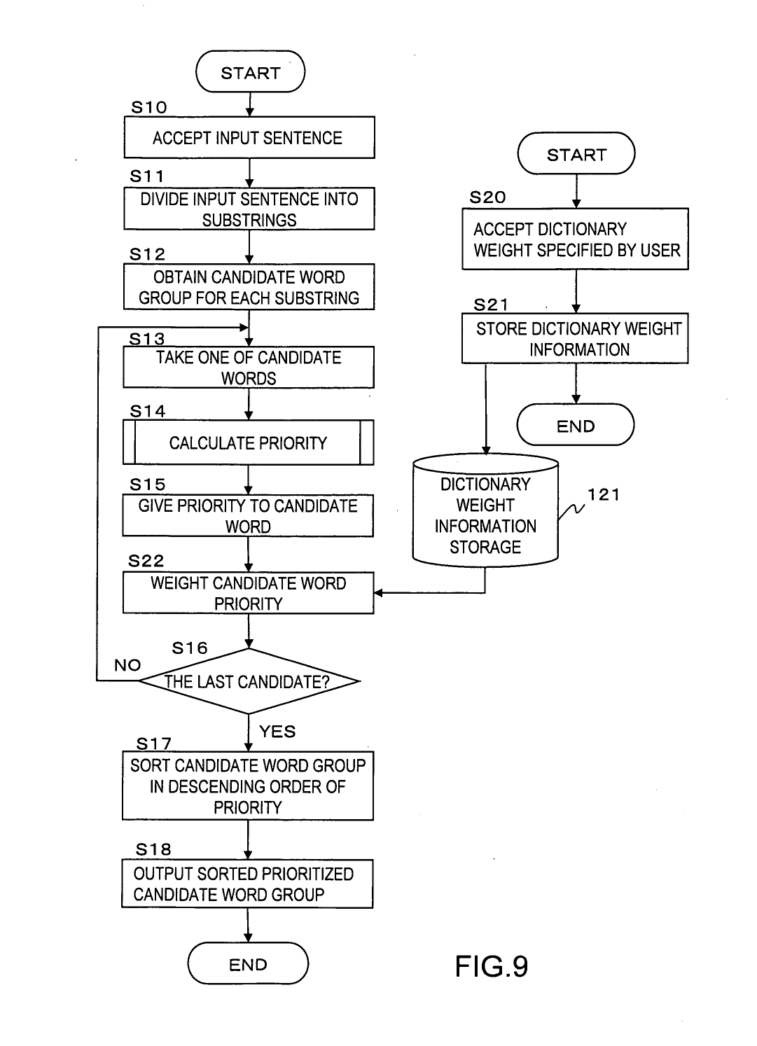

FIG. 9 illustrates a process flow of the invention in the second embodiment. In the process flow of FIG. 9, process steps denoted with the same number as the process flow of FIG. 3 are steps at which the same process is performed. The same applies to embodiments to be discussed hereinafter.

Prior to word translation information output, the dictionary weight setting section 123 displays the dictionary weight setting screen 310 and accepts designation of dictionary weights by a user (step S20).

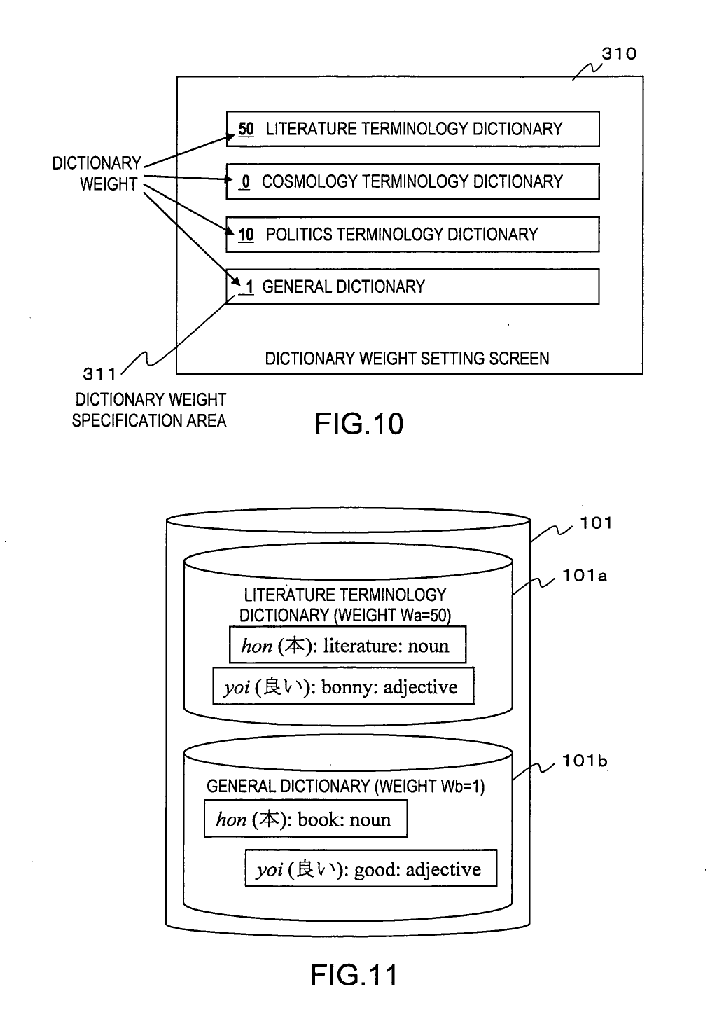

FIG. 10 shows an example of the dictionary weight setting screen 310. The dictionary weight setting screen 310 includes a dictionary weight specification area 311 in which dictionary weights for specialized dictionaries constituting the machine translation dictionary 101 are input.

Dictionary weight may be specified by way of a value indicating a certain degree or a value expressed as a percentage. Here, dictionary weight of 1 is a value that is the overall reference. Dictionary weight of 0 stands for a value indicating that the dictionary of interest is disabled.

The dictionary weight setting section 123 stores dictionary weights (dictionary weight information) for each dictionary that are input by a user in the dictionary weight specification area 311 in the dictionary weight information storage section 121 (step S21), and terminates its process.

Subsequently, the same processes as in the first embodiment are performed in word translation information output process, however, the candidate word priority 8 is weighted using dictionary weight information between step S15 and step S16 (step S22).

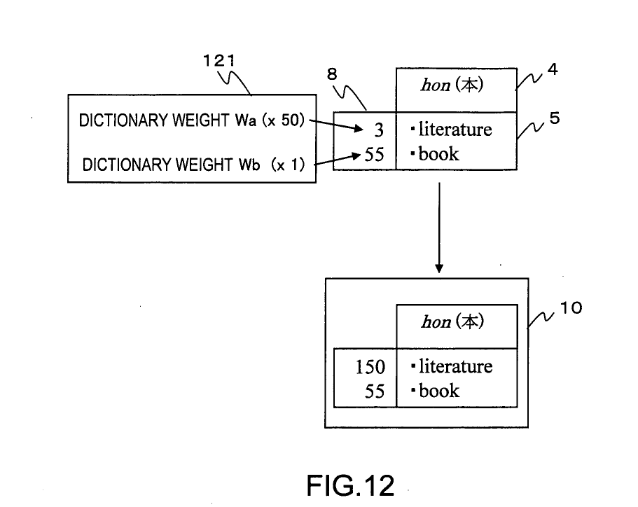

With respect to FIGS. 11 and 12, adjustment of candidate word priority 8 using dictionary weight will be described in more detail. Assume that the dictionary weight for a literature terminology dictionary 101a Wa is set to 50 and that for a general dictionary 101b Wb is set to 1 as dictionary weight information.

Also, as shown in FIG. 11, assume that the machine translation dictionary 101 consists of the literature terminology dictionary 101a and the general dictionary 101b, and that “literature” as an equivalent word of “hon ( [symbol] )“is stored in the literature terminology dictionary 101a and “book” as an equivalent word of “hon ( [symbol] )” is stored in the general dictionary 101b.

The candidate word priority calculation section 107 determines the word priority 8 for the candidate words “literature” and “book” to be 3 and 55, respectively, as shown in FIG. 12. Since the candidate word “literature” is extracted from the literature terminology dictionary 101a, its priority is 3×50 (Wa)=150. Also, since the candidate word “book” is extracted from the general dictionary 101b, its priority is 55×1(Wb)=55.

By adjusting the candidate word priority 8 using dictionary weight information in such a manner, priorities among candidates in the candidate word group 5 are changed to reflect dictionary weights and order of their presentation changes.

### Third Embodiment

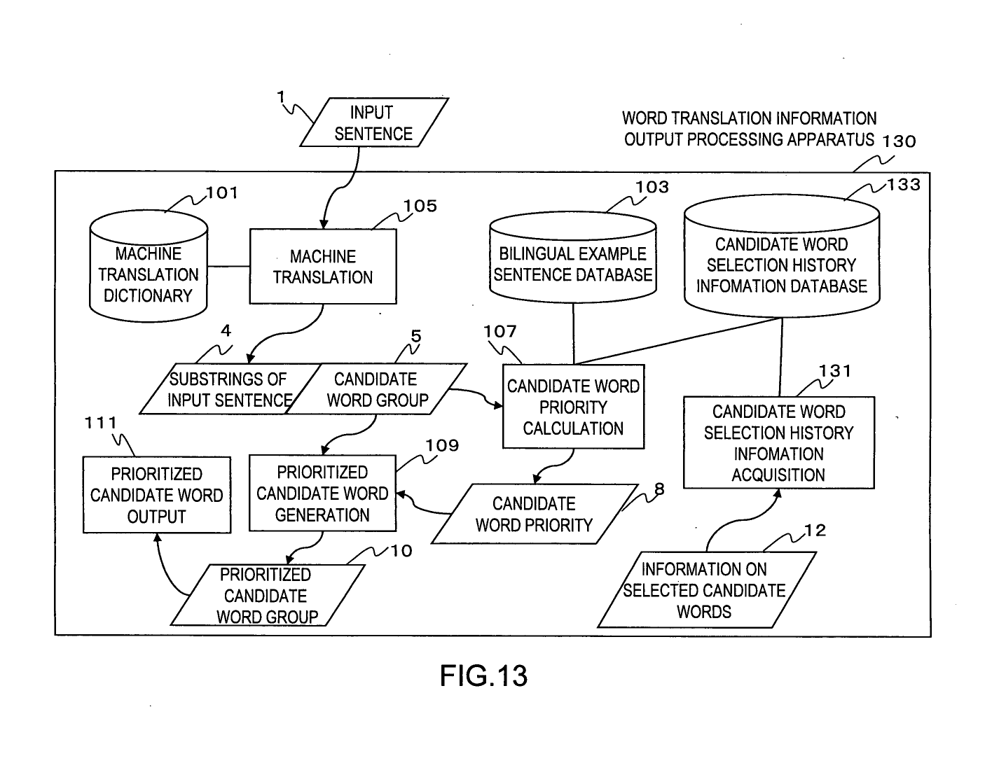

FIG. 13 illustrates an exemplary configuration of the invention in the third embodiment. A word translation information output processing apparatus 130 includes the machine translation dictionary 101, the bilingual example sentence database 103, the machine translation section 105, the candidate word priority calculation section 107, the prioritized candidate word generation section 109, the prioritized candidate word output section 111, a candidate word selection history information acquisition section 131, and a candidate word selection history information database 133.

The candidate word selection history information acquisition section 131 is process means that retrieves information 12 on selected candidate words based on the user's selection of words and passes the information to the candidate word selection history information database 133.

Information on selected candidate word 12 is information on history of word selecting operations including substrings 4 of an input sentence 1, selected candidate words, date of operation, and user name.

The candidate word selection history information database 133 is storage means for storing information on selected candidate words 12 as candidate word selection history information.

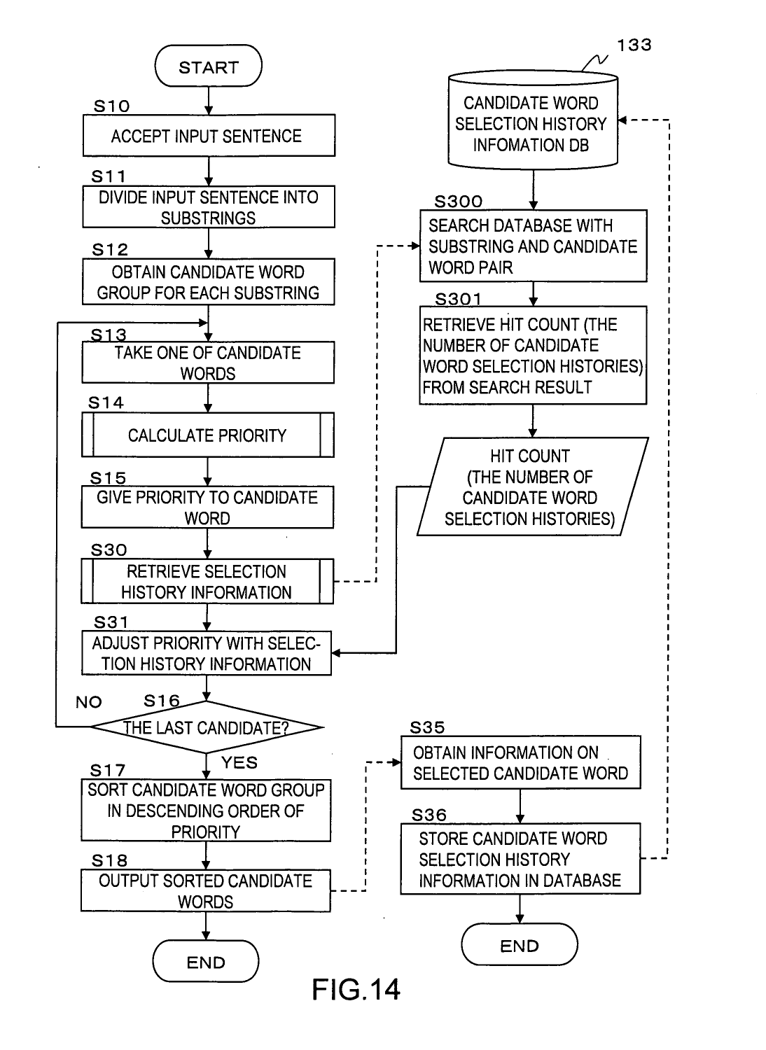

FIG. 14 shows a process flow of the invention in the third embodiment. The third embodiment performs the same processes as in the process flow in the first embodiment, however, steps S30 and S31 are performed between steps S15 and S16.

The candidate word priority calculation section 107 retrieves selection history information acquisition (step S30), and adjusts the candidate word priority 8 using the selection history information (step S31).

More detailed process flow at retrieval of selection history information acquisition (step S30) is as follows. When the candidate word priority calculation section 107 requests a search of the candidate word selection history information database 133, the candidate word selection history information database 133 searches for candidate word selection history information stored therein with the pair of the substring 4 and the candidate word as the search key (step S300). Then, it retrieves the number of candidate word selection histories (i.e., the hit count) as the search result and returns it to the candidate word priority calculation section 107 (step S301).

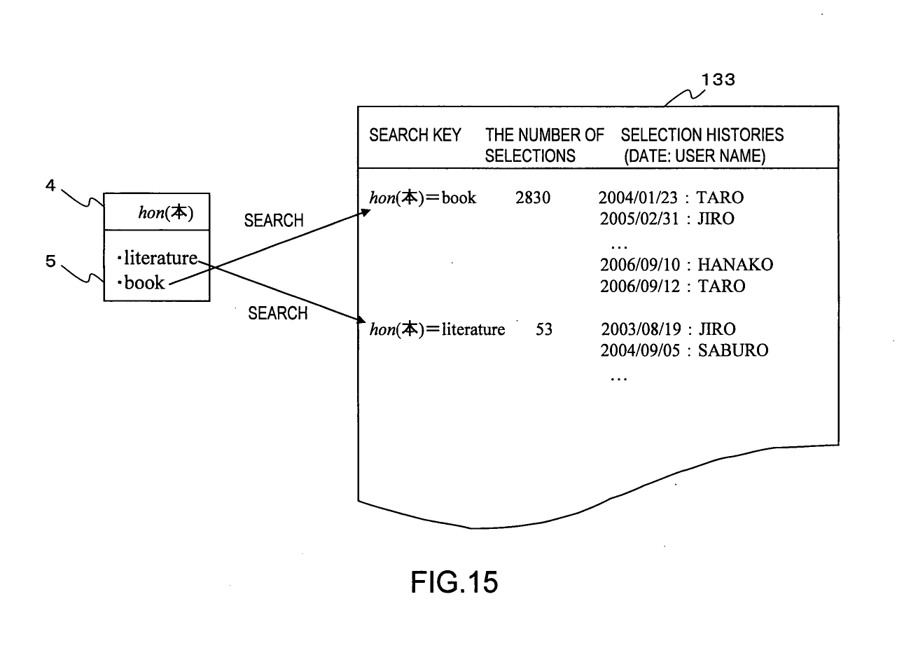

As shown in FIG. 15, the candidate word selection history information database 133 is searched with the pair of a substring “hon ( [symbol] )” and a candidate word “book” (hon ( [symbol] )=book) as the search key. Assume that 2830 results hit (are extracted) as candidate word selection history information about operation histories in which the candidate word “book” was selected for the substring “hon ( [symbol] )”. The hit count (2830) is returned to the candidate word priority calculation section 107. Similarly, when a search is conducted with the pair of the substring “hon ( [symbol] )” and a candidate word “literature” (hon ( [symbol] )=literature) as the search key, the number of resulting hits (53) with the search key is returned to the candidate word priority calculation section 107.

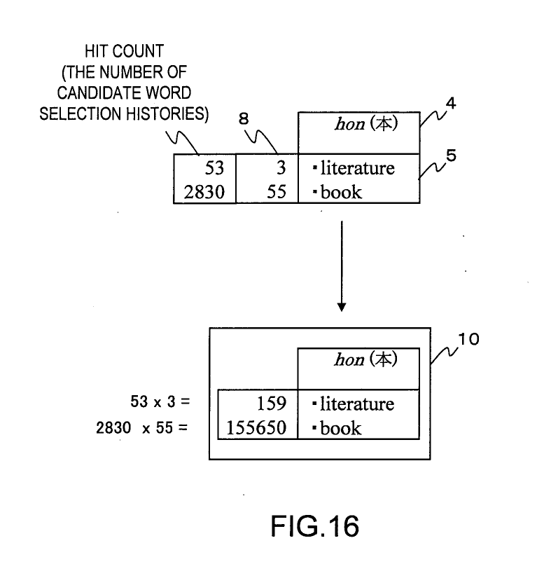

Thereafter, as shown in FIG. 16, the candidate word priority calculation section 107 multiplies the candidate word priority 8 by the hit count to adjust the priority 8. The adjusted candidate word priority 8 for candidate word “book” is 55×2830=155650. Similarly, the candidate word priority 8 for the word “literature” is 3×53=159.

Thus, by adjusting the candidate word priority 8 using the number of times the candidate word was selected that is provided from the candidate word selection history information, the priority of a word that the user actually selected becomes higher and will be presented highly ranked.

Then, after step S18, the candidate word selection history information database 133 monitors selection from candidate words by the user to obtain information on selected candidate words 12 (step S35), and registers the information with the database as candidate word selection history information (step S36).

### Fourth Embodiment

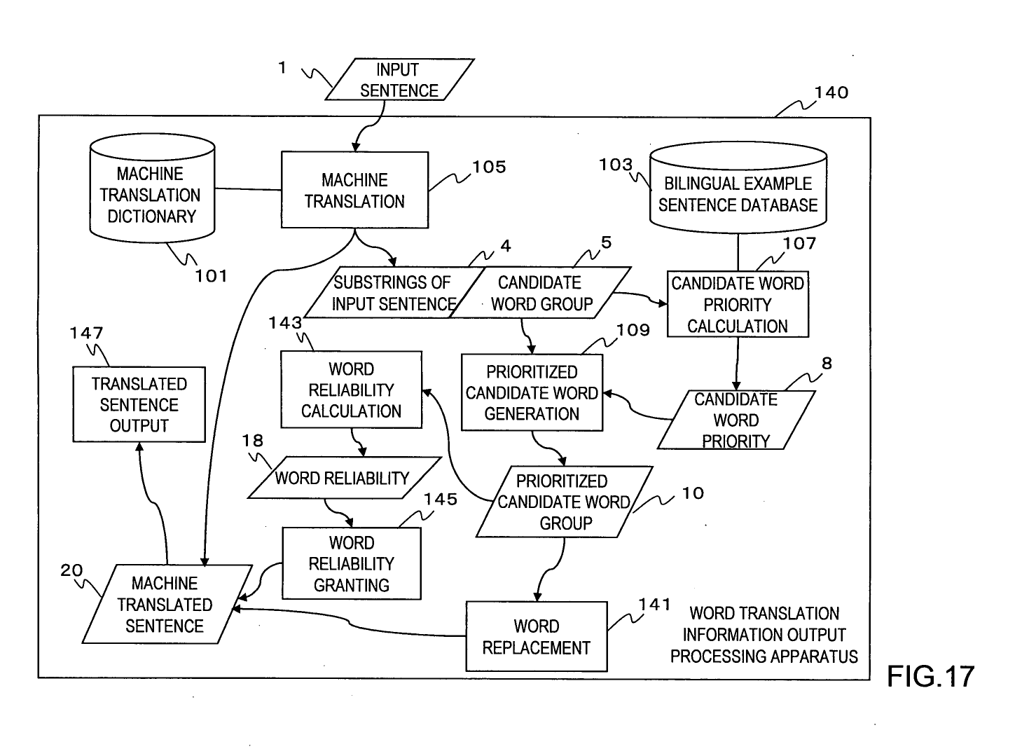

FIG. 17 illustrates an exemplary configuration of the invention in the fourth embodiment. A word translation information output processing apparatus 140 includes the machine translation dictionary 101, the bilingual example sentence database 103, the machine translation section 105, the candidate word priority calculation section 107, the prioritized candidate word generation section 109, a word replacement section 141, a word reliability calculation section 143, a word reliability granting section 145, and a translated sentence output section 147.

The word replacement section 141 is process means that determines a candidate word with the highest candidate word priority 8 (the highest priority candidate) from the prioritized candidate word group 10 to adopt it as a word corresponding to a substring 4 of the input sentence 1, and replaces a corresponding word for the substring 4 in the machine translated sentence 20 with the adopted highest priority candidate.

The word reliability calculation section 143 is process means that calculates the reliability of the adopted highest priority candidate from a certain priority distribution.

The word reliability granting section 145 is process means that gives reliability as translation to a word with the highest priority.

The translated sentence output section 147 is process means that modifies a machine translated sentence 20 which now contains the highest-priority candidate to an output form that reflects the reliability given to the candidate and outputs the same.

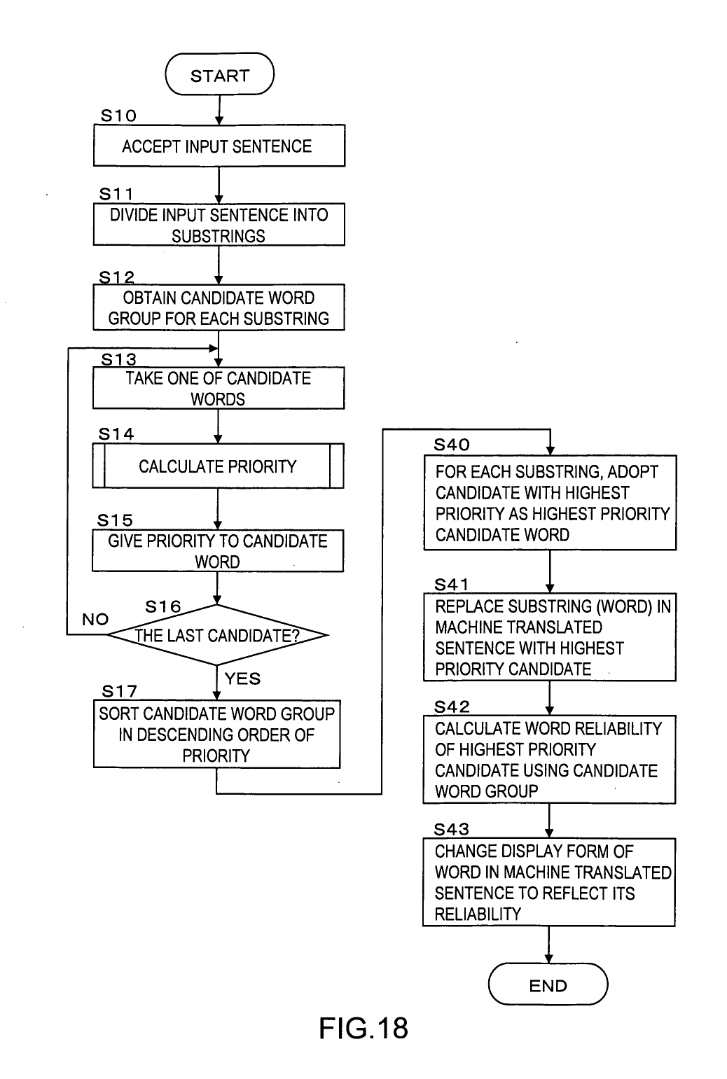

FIG. 18 illustrates a process flow of the invention in the fourth embodiment. The fourth embodiment performs the same processes as in the process flow of the first embodiment, however, the following processes are performed after steps S10 to S17.

The word replacement section 141 adopts a candidate word with the highest candidate word priority 8 in the corresponding candidate word group 5 as the highest-priority candidate for each substring 4 of the input sentence 1 (step S40). An appropriate word within the machine-translated sentence 20 is replaced with the highest-priority candidate (step S41). The word reliability calculation section 143 calculates the reliability as translation of the highest-priority candidate based on the candidate word group 5 (step S42). Reliability as translation is determined from the priority of the highest priority candidate on the basis of a certain priority distribution. For determination of the certain priority distribution, rules for word reliability are employed.

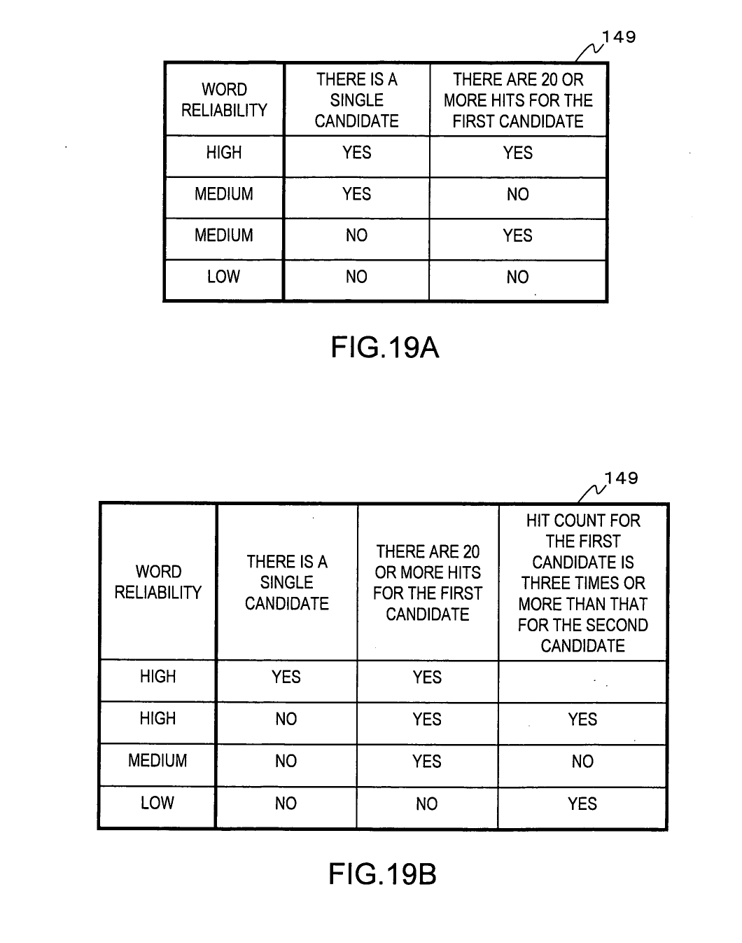

FIGS. 19A and 19B show examples of word reliability rule 149. Word reliability rule 149 of FIG. 19A is for a case there are two conditions for determining the reliability of a candidate word. Here, word reliability 18 is determined on two conditions:

1. The candidate word group consists of a single candidate word; and

2. There are twenty or more hits for the first candidate (i.e., the highest-priority candidate).

For example, for a certain candidate word, if the candidate word group 5 to which it belongs satisfies both the first and second conditions, its word reliability 18 is determined to be “high”. If the candidate word group 5 to which the candidate belongs satisfies only one of the first and second conditions, its word reliability 18 is determined to be “medium”. If the candidate word group 5 satisfies neither the first nor the second condition, its word reliability 18 is determined to be “low”.

Word reliability rule 149 of FIG. 19B is for a case there are three conditions for determining the reliability of a candidate word. In this case, in addition to the two conditions above, it is also determined whether or not the third condition “the number of hits for the first candidate is three times or more than that for the second candidate” is satisfied.

By using the difference in hits between the first and second candidates as a determination condition, case sorting of word reliability is possible when there are a number of candidate words. Even if there are a plurality of candidate words, when the number of hits for the first candidate is by far more than that for the second and lower candidates, the reliability of the first candidate as translation can be considered to be high. On the contrary, when the difference in hits between the first candidate and the second and lower candidates is small, the second candidate may be selected as translation depending on the context, so that the word reliability 18 of the first candidate can be determined to be “medium”.

The word reliability of “book”, the first candidate in the candidate word group 5 of FIG. 6, is determined using the word reliability rules 149 of FIGS. 19A and 19B. When the word reliability rule 149 of FIG. 19A is used for the candidate word group 5, candidate word “book” does not satisfy the first condition but the second condition. Thus, the word reliability 18 of the candidate word “book” is determined to be “medium”. When the word reliability rule 149 of FIG. 19B is used, the candidate word “book” does not satisfy the first condition but the second and third conditions. Thus, the word reliability 18 of candidate word “book” is determined to be “high”.

Then, the translated sentence output section 147 changes the display form of the word in the machine-translated sentence 20 based on its word reliability 18 (step S43).

The translated sentence output section 147 displays a word with an underline when its word reliability 18 in the machine translated sentence 20 is “high”, in italics when “medium”, and in boldface when “low”. Alternatively, color of letters may be varied according to word reliability 18.

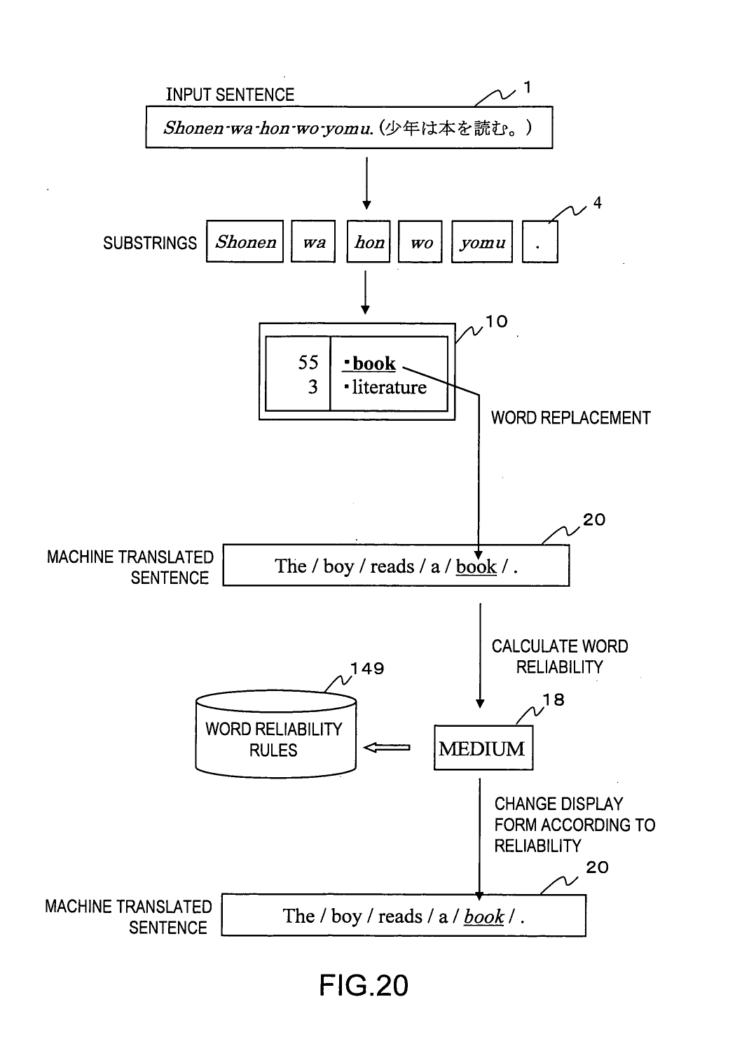

Referring to FIG. 20, process up to output of the machine translated sentence 20 will be described in more detail. Assume that candidate words in the candidate word group 5 for the substring “hon ( [symbol] )” of the input sentence 1 have been sorted in the order of “book”—“literature” based on their candidate word priorities 8.

The word replacement section 141 detects the candidate word “book“that has the highest candidate word priority 8 (the first candidate) and adopts it as translation of the substring “hon ( [symbol] )”. Meanwhile, the machine translation section 105 outputs a machine-translated sentence 20 “The/boy/reads/a/book/.”

The word replacement section 141 replaces an appropriate word in the machine-translated sentence 20 with the candidate word “book” (the first candidate).

Further, the word reliability calculation section 143 calculates the word reliability 18 of the candidate word “book” to be “medium” according to the word reliability rule 149 of FIG. 19A.

The translated sentence output section 147 changes the “book” in the machine translated sentence 20 to italics indicating its word reliability 18 of “medium” and outputs the machine-translated sentence 20.

### Fifth Embodiment

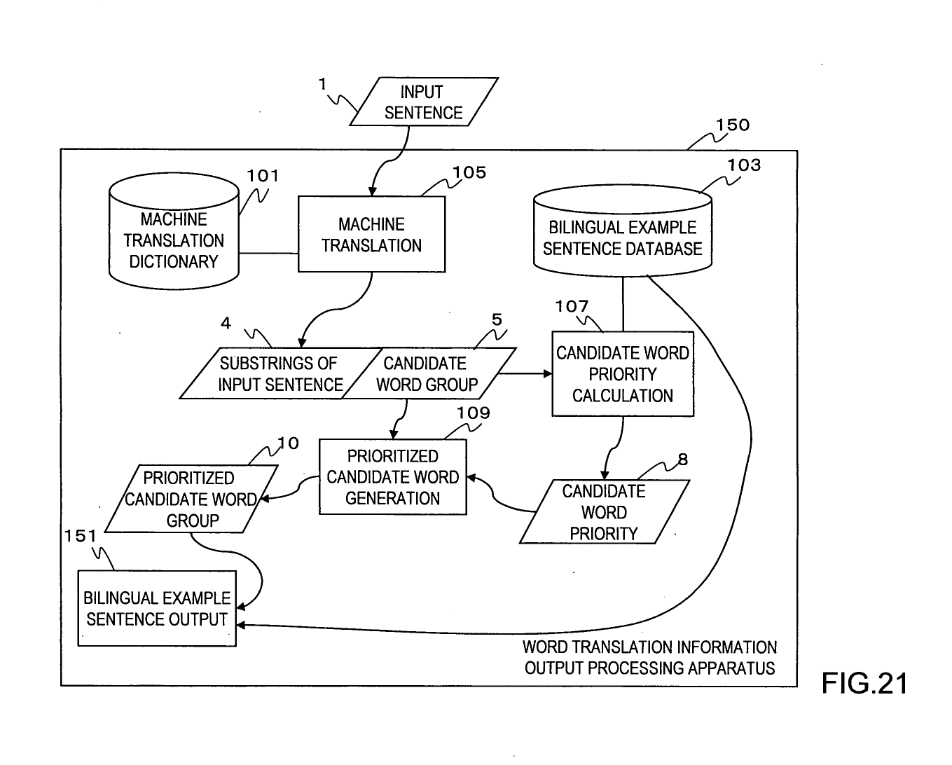

FIG. 21 illustrates an exemplary configuration of the invention in the fifth embodiment. A word translation information output processing apparatus 150 includes the machine translation dictionary 101, the bilingual example sentence database 103, the machine translation section 105, the candidate word priority calculation section 107, the prioritized candidate word generation section 109, and a bilingual example sentence output section 151.

The bilingual example sentence output section 151 is process means that, when it outputs bilingual example sentences that are found in the bilingual example sentence database 103 with a candidate word specified by the user from the candidate word group 5 as the search key, displays the sentences with the candidate word contained in the target language sentence of the bilingual example sentences aligned with the corresponding substring 4 in the source language sentence vertically relative to the orientation of the sentences.

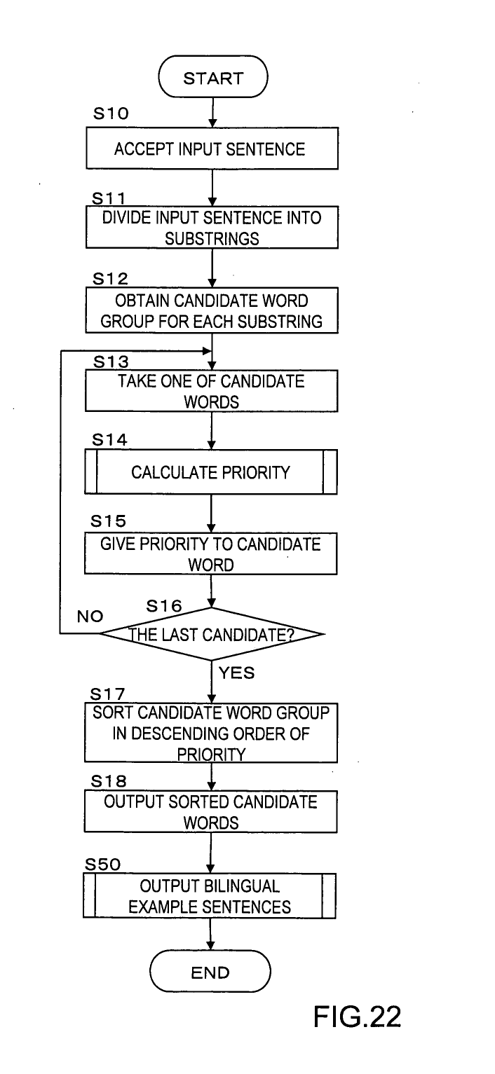

FIG. 22 shows a process flow of the invention in the fifth embodiment. The fifth embodiment performs the same processes as in the process flow of the first embodiment, however, after steps S10 to S18, output of bilingual example sentences is performed by the bilingual example sentence output section 151 (step S50).

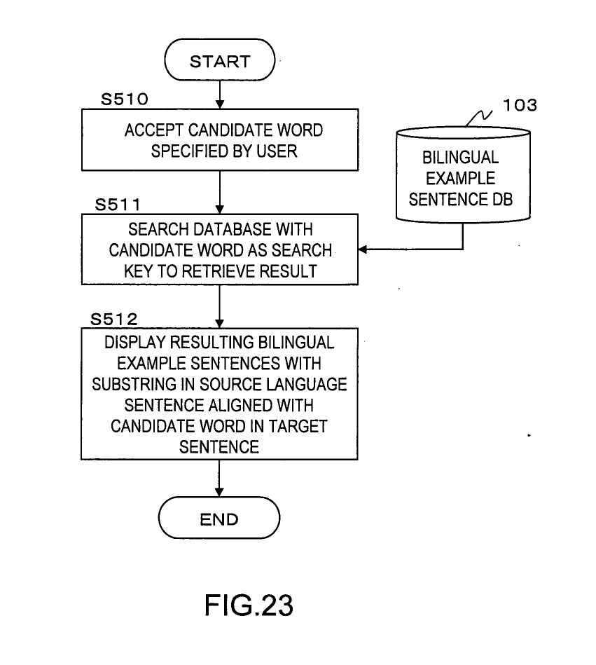

FIG. 23 illustrates a detailed process flow of the bilingual example sentence output. When the bilingual example sentence output section 151 accepts a candidate word specified by the user (step S510), the bilingual example sentence database 103 searches for bilingual example sentences accumulated therein with the candidate word as the search key, and returns bilingual example sentences as the search result to the bilingual example sentence output section 151 (step S511).

The bilingual example sentence output section 151 locates the candidate word in the target language sentence of the bilingual example sentences and the substring 4 in the source language sentence that corresponds to the candidate word used as the search key, and outputs the bilingual example sentences (i.e., a pair of a source language sentence and a target language sentence) with the located substring 4 and the candidate word aligned on a display device, for example (step S512).

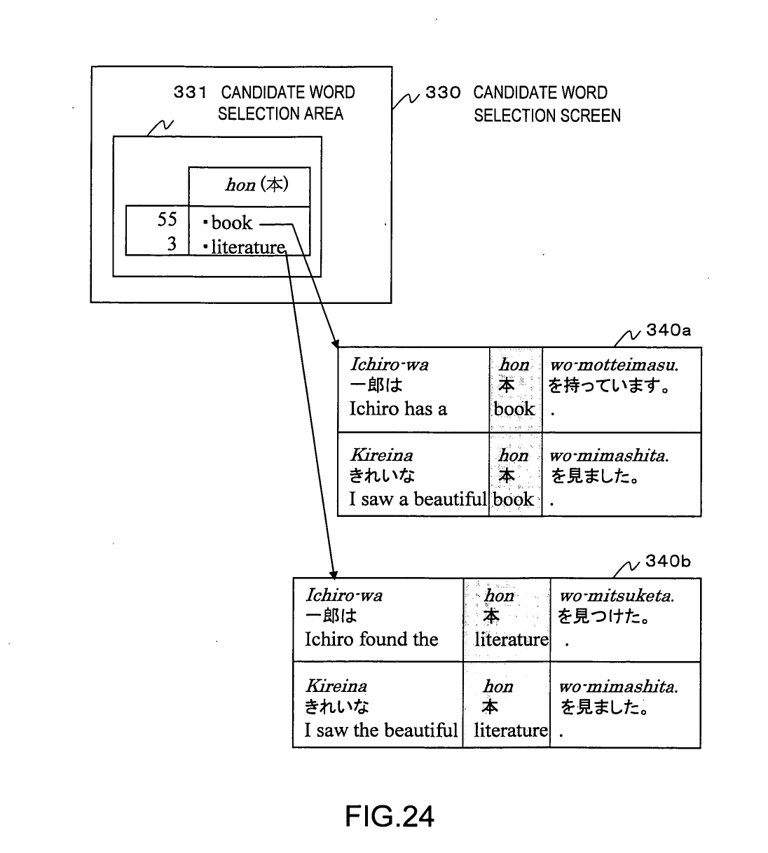

As shown in FIG. 24, the bilingual example sentence output section 151 displays the prioritized candidate word group 10 in the candidate word selection area 331 on the candidate word selection screen 330 and prompts the user to select a candidate word for which the user wants to search for example sentences. Then, it displays bilingual example sentences found with the candidate word selected on the candidate word selection screen 330 as the search key on the bilingual example sentence display screen 340a, with the candidate word used as the search key in the target language sentence aligned with the corresponding substring 4 in the source language sentence on a vertical line relative to the orientation of sentences.

If the length of example sentences exceeds the width of the display area, the sentences are partially displayed centering the position of aligned candidate word in the target language sentence and the corresponding substring 4 in the source language sentence. This enables the user to easily find the neighborhood of the candidate word of interest and the corresponding substring (word).

On the candidate word selection screen 330, if candidate word “book“is selected, the result of a search with “book” as the search key is displayed on the bilingual example sentence display screen 340a. If candidate word “literature” is selected on the candidate word selection screen 330, the result of a search with “hon ( [symbol] )=literature” as the search key is displayed on the bilingual example sentence display screen 340b.

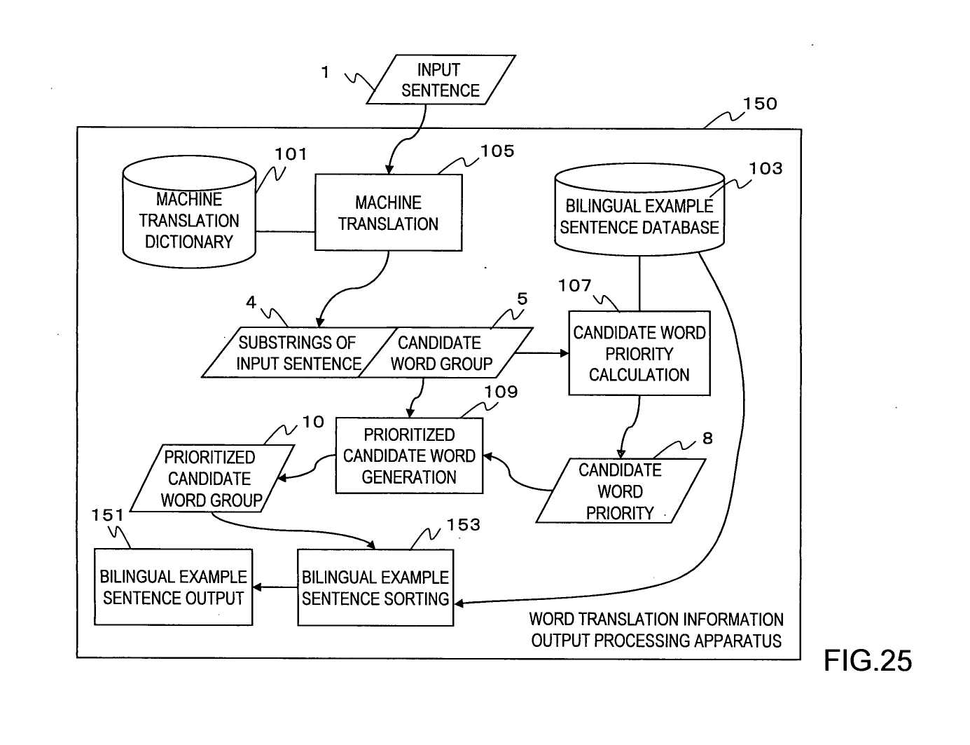

In the fifth embodiment, as shown in FIG. 25, the word translation information output processing apparatus 150 may further include a bilingual example sentence sorting section 153. The bilingual example sentence sorting section 153 is process means that sorts bilingual example sentences found in a search with a candidate word selected by a user based on case frame information of the source language example sentence. In this case, the bilingual example sentence output section 151 outputs bilingual example sentences that have been sorted by the bilingual example sentence sorting section 153.

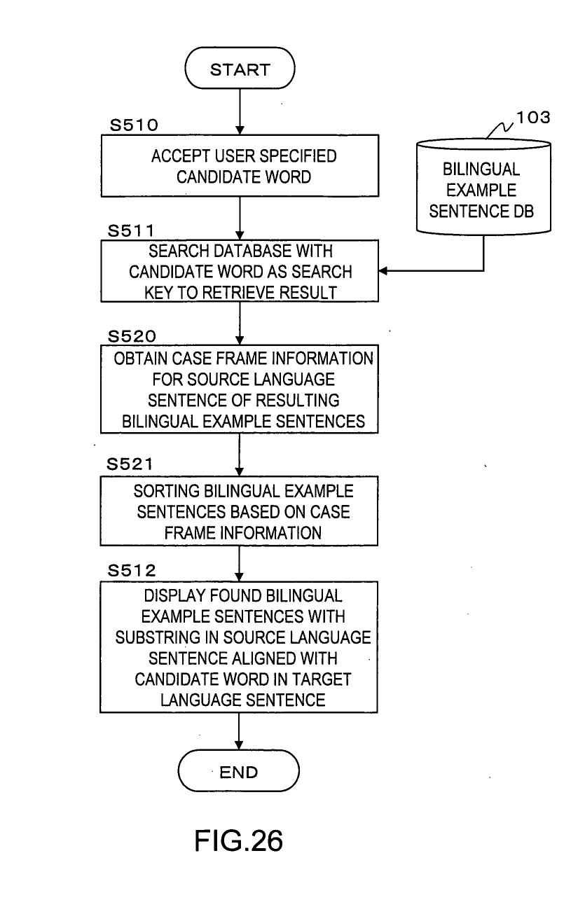

FIG. 26 illustrates a process flow of the invention in the fifth embodiment with the configuration shown in FIG. 25. Here, the following processes are performed between steps S511 and S512.

The bilingual example sentence sorting section 153 obtains case frame information for the source language sentence of bilingual example sentences found in a search of the bilingual example sentence database 103 (step S520), and sorts the bilingual example sentences based on the case frame information (step S521).

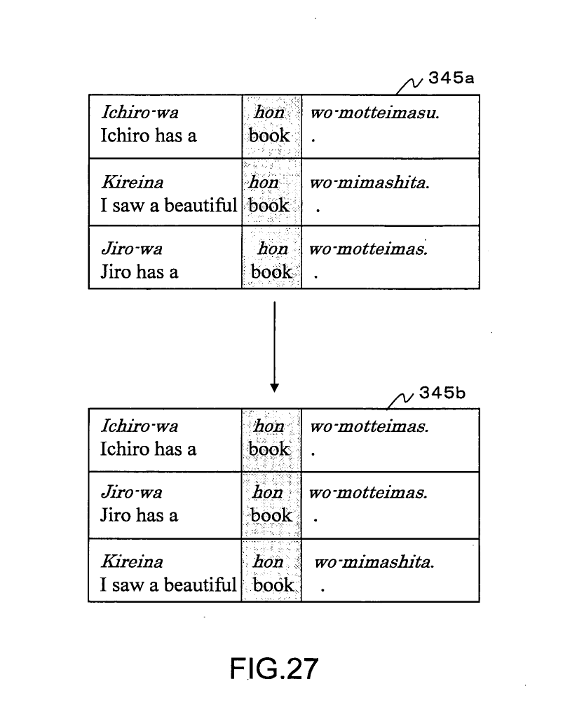

For example, in the case of the bilingual example sentences on the bilingual example sentence display screen 345a shown in FIG. 27, after source language sentences of the bilingual example sentences are sorted with their predicate verb as the key, target language example sentences for the source language sentences having the verb “motte-imasu ( [symbol] (have))” are displayed together, as shown on the bilingual example sentence display screen 345b.

### Sixth Embodiment

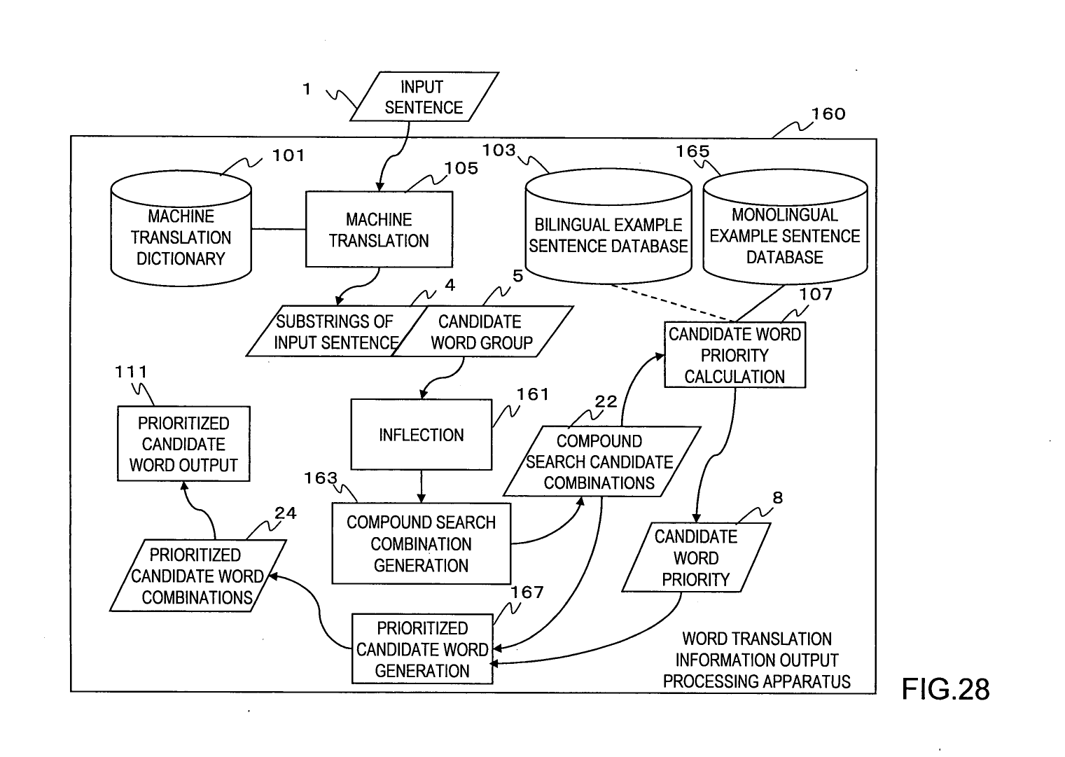

FIG. 28 illustrates an exemplary configuration of the invention in the sixth embodiment. A word translation information output processing apparatus 160 includes the machine translation dictionary 101, the bilingual example sentence database 103, the machine translation section 105, the candidate word priority calculation section 107, the prioritized candidate word output section 111, a inflection section 161, a compound search combination generation section 163, a monolingual example sentence database 165, and the prioritized candidate word generation section 167.

The inflection section 161 is a process means that inflects a candidate word in a candidate word group 5 to generate its inflected forms. Generation of inflected forms includes inflection of ending as well as inflection from noun to adjective and inflection of singular/plural form.

The compound word search combination generation section 163 is process means that combines or sorts candidate words using candidate words and their inflected forms which are generated at the inflection section 161 to generate a compound word search candidate word combinations 22.

The monolingual example sentence database 165 is a database that accumulates only example sentences written in the target language.

The prioritized candidate word generation section 167 is process means that gives the candidate word priority 8 to each compound word search candidate word combination 22 to generate the prioritized candidate word combinations 24.

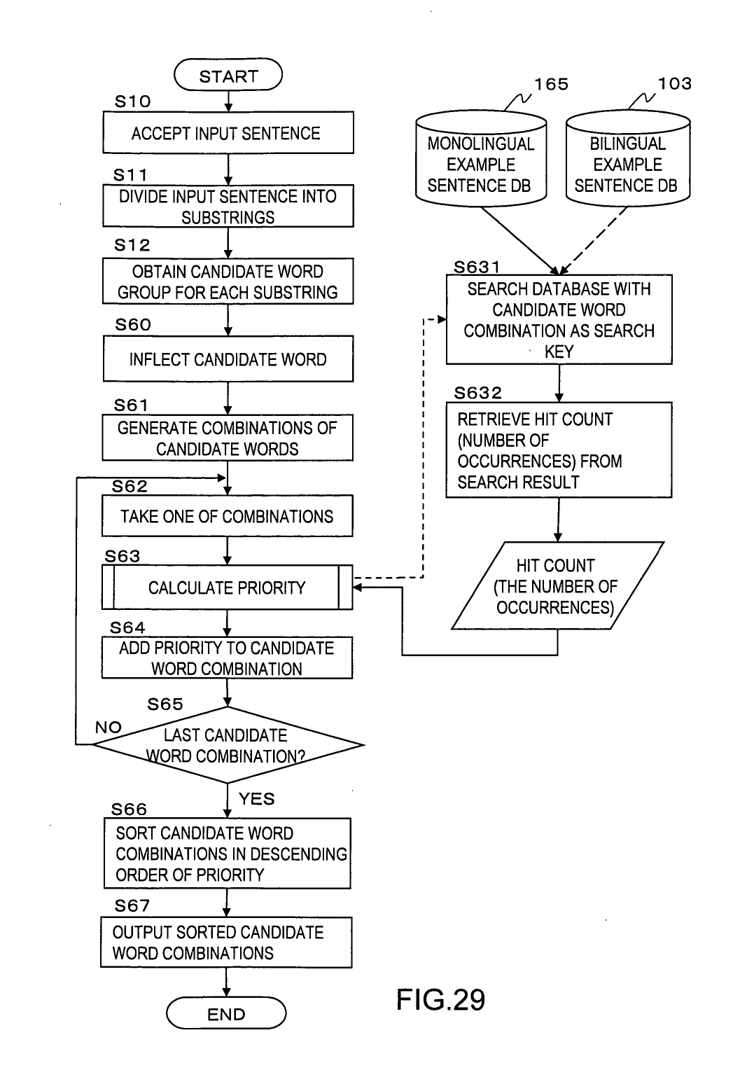

FIG. 29 illustrates a process flow of the invention in the sixth embodiment. The sixth embodiment performs the same processes as in the process flow of the first embodiment, however, the following processes are performed after steps S10 to S12.

The inflection section 161 inflects candidates in the candidate word group 5 to generate their inflected forms (step S60), and the compound word search combination generation section 163 combines/sorts the candidate words using the candidate words and their inflected forms to generate the compound word search candidate word combinations 22 (step S61).

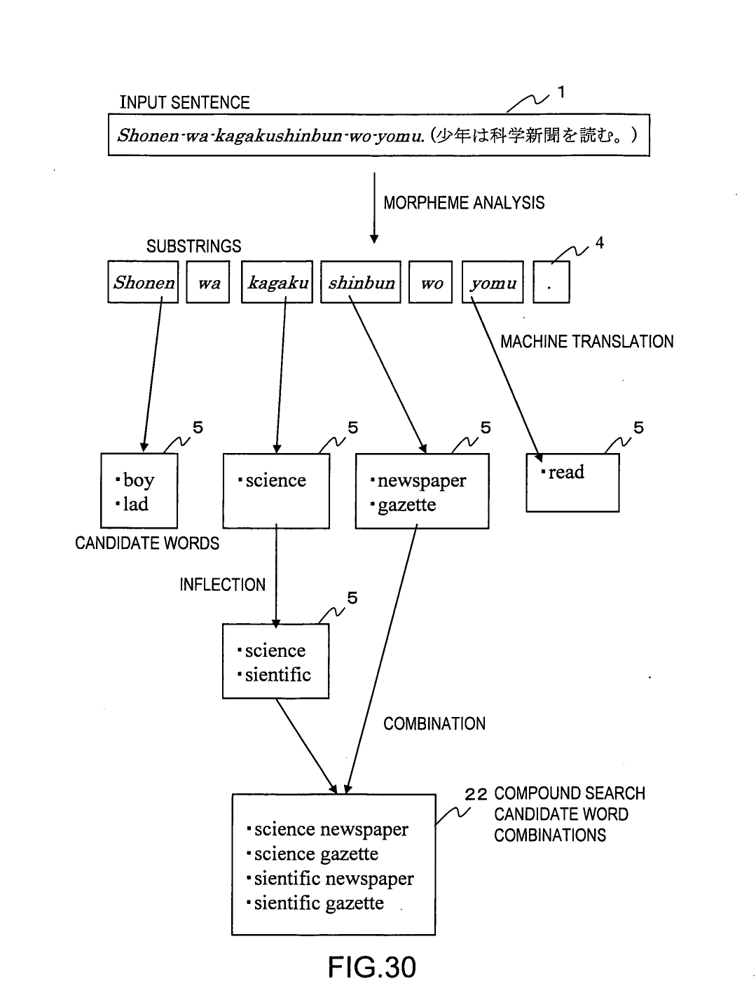

As illustrated in FIG. 30, when an input sentence “Shonen-wa-kagakushinbun-woyomu( [symbol] (A boy read a science newspaper.))” is accepted, the input sentence 1 is divided into substrings 4: “shonen ( [symbol] (boy))”, “wa ( [symbol] (case particle ))”, “kagaku ( [symbol] (science))”, “shinbun ( [symbol] (newspaper))”, “wo ( [symbol] (case particle))”, “yomu ( [symbol] (read))”, “ [symbol] ”. Among these substrings 4, for each of the substrings 4 “shonen ( [symbol] )”, “kagaku ( [symbol] )”, “shinbun ( [symbol] )”, and “yomu ( [symbol] )”, a candidate word group 5 is obtained.

Although the substrings 4 “kagaku ( [symbol] )” and “shinbun ( [symbol] )” are processed as two substrings, they are actually a compound word “kagakushinbun ( [symbol] )”. Thus, in this embodiment, candidate word combinations that take into consideration inflected forms and compound words are generated.

Assume that for “kagaku ( [symbol] )” and “shinbun ( [symbol] )”, candidate word groups 5 of “science” and “newspaper, gazette” are obtained, respectively. The inflection section 161 inflects “science” provided as a candidate word for the substring “kagaku ( [symbol] )” to generate a inflected form “scientific”. Then, the compound word search combination generation section 163 uses the candidate word “science” for substring “kagaku ( [symbol] )”, its inflected form “scientific”, and “newspaper, gazette” for substring “newspaper” to generate compound word search candidate word combinations 22: “science newspaper”, “science gazette”, “scientific newspaper”, and “scientific gazette”.

The candidate word priority calculation section 107 takes one of the compound word search candidate word combinations 22 (step S62), and calculates its priority (step S63).

Detailed process of priority calculation (step S63) is as follows. When the candidate word priority calculation section 107 requests a search of the monolingual example sentence database 165, the bilingual example sentence database 103 searches for example sentences accumulated in the monolingual example sentence database 165 with a compound word search candidate word combination 22 as the search key (step S631). And it retrieves the number of found example sentences as the search result and returns the same to the candidate word priority calculation section 107 (step S632).

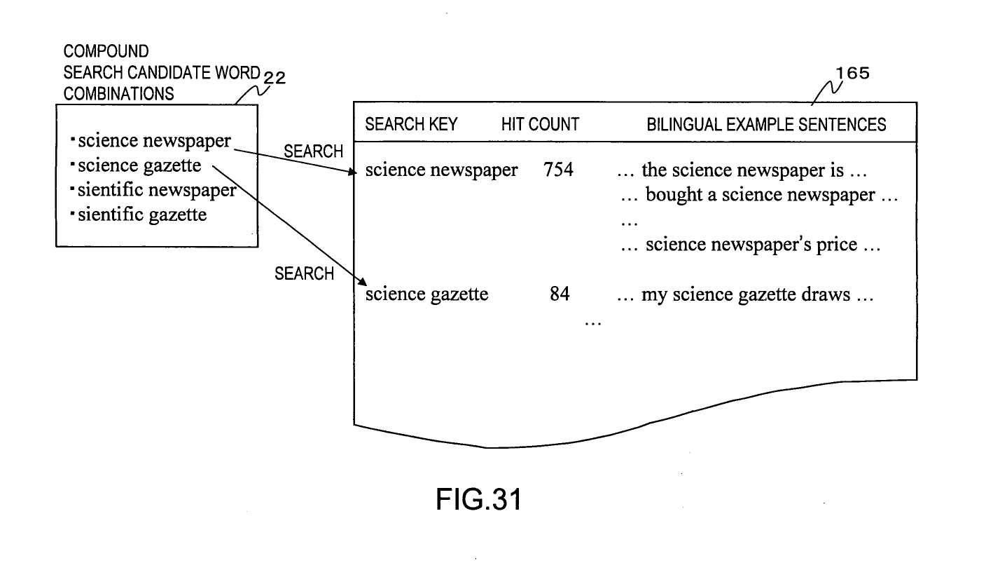

As shown in FIG. 31, the monolingual example sentence database 165 is searched with “science newspaper”, one of the compound word search candidate word combinations 22, as the search key. Assume that 754 sentences hit (are extracted) as the search result. This hit count of the bilingual example sentences is set as the candidate word priority 8 for the compound word search candidate word combination “science newspaper”.

Similarly, if 84 sentences hit in a search of the monolingual example sentence database 165 with the compound word search candidate word combination “science gazette” as the search key, the hit count is obtained and set as its candidate word priority 8.

Although the description here referred to a case where the candidate word priority calculation section 107 requests a search of the monolingual example sentence database 165, it may request a search of the bilingual example sentence database 103. In that case, the bilingual example sentence database 103 performs a search with a compound word search candidate word combination 22 as the search key and retrieves bilingual example sentences as the search result.

The prioritized candidate word generation section 167 gives resulting candidate word priority 8 to each compound word search candidate word combination 22 to generate prioritized candidate word combinations 24 (step S64). If the compound word search candidate word combination 22 processed is not the last one generated (NO at step S65), the process returns to step S62 and repeats steps S62 to S65 until the current combination is the last compound word search candidate word combination 22 (YES at step S65).

Then, the prioritized candidate word output section 111 sorts the prioritized candidate word combinations 24 in descending order of candidate word priority 8 (step S66), and outputs sorted prioritized candidate word combinations 24 (step S67).

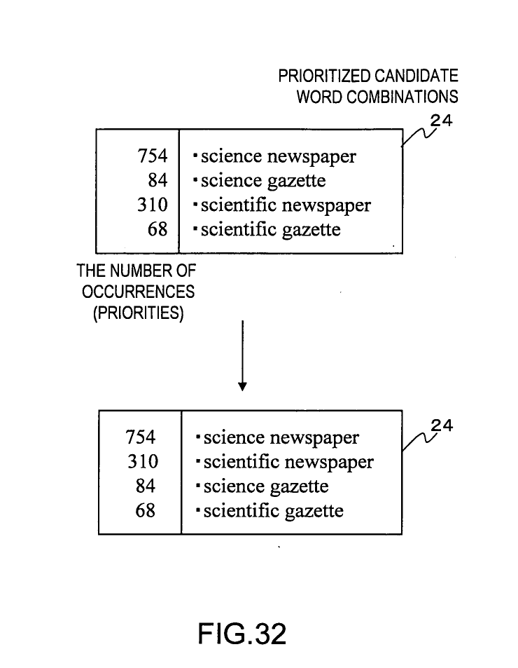

As shown in FIG. 32, assume that the order generated as the compound word search candidate word combinations 22 is “science newspaper”—“science gazette”—“scientific newspaper”—“scientific gazette”. Sorting the prioritized candidate word combinations 24 based on their candidate word priority 8 results in the order of “science newspaper”—“scientific newspaper”—“science gazette”—“scientific gazette”.

The invention has been thus described with respect to its embodiments, however, various modifications thereof are of course possible without departing from the spirit of the invention.

Any two or more of the embodiments described above may be combined or all the embodiments may be combined.

Also, the description of the embodiments described processes assuming that bilingual example sentences accumulated in the bilingual example sentence database have analysis information added thereto. However, the invention may employ a bilingual example sentence database in which analysis information is not added to accumulated bilingual example sentences. In this case, the word translation information display output apparatus is configured to include process means for performing morphine analysis and parsing.

Further, in the description of the embodiments above, the number of target language example sentences including a candidate word that are found in a search of a bilingual example sentence database is directly used as priority for a candidate word. However, the candidate word priority calculation section of the invention may calculate priority of a candidate word based on information on various types of occurrences in target language sentences, e.g., the frequency of occurrence per part of speech.

Also, the present invention may be implemented as a processing program that is read and executed by a computer. The processing program implementing the invention may be stored on an appropriate computer-readable storage medium such as a portable memory, semiconductor memory, and hard disk, and may be provided as recorded on such a storage medium or provided by transmission utilizing various communication networks via a communication interface.

What is claimed is:

1. An apparatus for word translation information output processing, comprising:
a translation dictionary in which words in a target language corresponding to words in a source language are accumulated;
a machine translation section that applies machine translation process to an input sentence written in said source language to generate a translated sentence in said target language, and obtains one or more candidate words extracted from said translation dictionary for each of substrings of said input sentence that are generated through morpheme analysis executed in said machine translation process;
a bilingual example sentence database which accumulates bilingual example sentences that are pairs of source language sentences written in said source language and corresponding target language sentences written in said target language and that have certain analysis information added thereto for both said source language and said target language example sentences;
a candidate word priority calculation section that calculates the priority for output of each candidate for said substrings based on its occurrence information that indicates the frequency the candidate word appears in bilingual example sentences in said bilingual example sentence database;
a prioritized candidate word generation section that generates a prioritized candidate word that is obtained by granting said priority to said candidate word; and
a prioritized candidate word output processing section that sorts one or more prioritized candidate words corresponding to a specified substring of said input sentence in descending order of said priority and displays the same.

2. The apparatus for word translation information output processing according to claim 1, comprising a dictionary weight setting section for, when said translation dictionary is composed of a plurality of specialized dictionaries for specialized fields, setting a dictionary weight for each of said specialized dictionaries;
wherein said candidate word priority calculation section calculates the priority of said candidate words using said dictionary weight.

3. The apparatus for word translation information output processing according to claim 1, further comprising a candidate word selection history information accumulation section for accumulating candidate word selection history information relating to candidate words selected by a user from candidate words output in past word translation information output processing;
wherein said candidate word priority calculation section calculates priorities of candidate words for a substring of said input sentence using said candidate word selection history information.

4. The apparatus for word translation information output processing according to claim 1, comprising:
a word replacement section that adopts a candidate word with the highest priority from candidate words for a substring of said input sentence as translation for use in said translated sentence, and replaces a word in said translated sentence with said candidate word with the highest priority;
a word reliability calculation section that calculates word reliability of said adopted highest priority candidate word from a certain priority distribution, and grants said word reliability to said highest priority candidate word put into said translated sentence; and
a translated sentence output section that changes said highest priority candidate word in said translated sentence to a certain display form reflecting its word reliability and outputs said translated sentence.

5. The apparatus for word translation information output processing according to claim 1, comprising a bilingual example sentence output section that extracts bilingual example sentences containing a candidate word specified from candidate words for a substring of said input sentence from said bilingual example sentence database, and outputs said extracted bilingual example sentences with the substring corresponding to said candidate word in a source language sentence and said candidate word in the source language sentence aligned.

6. The apparatus for word translation information output processing according to claim 1, comprising a candidate word combination generation section that generates inflected forms from candidate words obtained by said machine translation section and combines or sorts said candidate words and their inflected forms to generate candidate word combinations for search;
wherein said candidate word priority calculation section calculates said priority for each of said candidate word combinations for search.

7. The apparatus for word translation information output processing program according to claim 3, comprising a candidate word selection history information acquisition section that detects a candidate word selected by a used from candidate words for a substring of said input sentence, and stores candidate word selection history information on said detected candidate word in said candidate word selection history information accumulation section.

8. The apparatus for word translation information output processing according to claim 4, wherein said word reliability calculation section calculates said word reliability using an absolute value regarding the occurrence of said highest priority candidate word within said bilingual example sentence database and using difference in word reliability between said highest priority candidate word and other candidate words in the candidate word group that contains said highest priority candidate word.

9. The apparatus for word translation information output processing according to claim 4, comprising an example sentence sorting section that sorts said bilingual example sentences based on certain analysis information added to the source language sentence of said bilingual example sentences, and
said bilingual example sentence output section displays said bilingual example sentences in said sorted order.

10. The apparatus for word translation information output processing according to claim 6, wherein said candidate word combination generation section replaces said candidate word with its root form, and generates inflected forms from the root form of said candidate word.

11. The apparatus for word translation information output processing according to claim 6, wherein said candidate word combination generation section has combination rule information that defines rules for combination of inflected forms or sorting of said candidate words, and generates said candidate word combinations based on said combination rule information.

12. A method for word translation information output processing executed by a computer, comprising steps of:
accessing a translation dictionary in which words in a target language corresponding to words in a source language are accumulated, applying machine translation process to an input sentence written in said source language to generate a translated sentence in said target language, and obtaining one or more candidate words extracted from said translation dictionary for each of substrings of said input sentence that are generated through morpheme analysis executed in said machine translation process;
accessing a bilingual example sentence database which accumulates bilingual example sentences that are pairs of source language sentences written in said source language and corresponding target language sentences written in said target language and that have certain analysis information added thereto for both said source language and said target language example sentences, and calculating the priority for output of each candidate word for said substrings based on its occurrence information that indicates the frequency said candidate word appears in bilingual example sentences in said bilingual example sentence database;
generating a prioritized candidate word that is obtained by granting said priority to said candidate word; and
sorting one or more prioritized candidate words corresponding to a specified substring of said input sentence in descending order of said priority and displaying the same.

13. A computer-readable medium storing a program which enables a computer to perform as an apparatus for word translation information output processing, comprising:
a translation dictionary in which words in a target language corresponding to words in a source language are accumulated;
a machine translation section that applies machine translation process to an input sentence written in said source language to generate a translated sentence in said target language, and obtains one or more candidate words extracted from said translation dictionary for each of substrings of said input sentence that are generated through morpheme analysis executed in said machine translation process;
a bilingual example sentence database which accumulates bilingual example sentences that are pairs of source language sentences written in said source language and corresponding target language sentences written in said target language and that have certain analysis information added thereto for both said source language and said target language example sentences;
a candidate word priority calculation section that calculates the priority for output of each candidate for said substrings based on its occurrence information that indicates the frequency the candidate word appears in bilingual example sentences in said bilingual example sentence database;
a prioritized candidate word generation section that generates a prioritized candidate word that is obtained by granting said priority to said candidate word; and
a prioritized candidate word output processing section that sorts one or more prioritized candidate words corresponding to a specified substring of said input sentence in descending order of said priority and displays the same.
